(19) United States
(12) Patent Application Publication
(10) Pub. No.: US 2021/0116682 A1
(43) Pub. Date: Apr. 22, 2021

(54) OPTICAL ZOOM DEVICE

(71) Applicant: OPTOTUNE CONSUMER AG, Dietikon (CH)

(72) Inventors: Stephan SMOLKA, Zürich (CH); Michael BÜELER, Vogelsang (CH); Manuel ASCHWANDEN, Allenwinden (CH); Johannes HAASE, Dietikon (CH); Frank BOSE, Dietikon (CH)

(73) Assignee: OPTOTUNE CONSUMER AG, Dietikon (CH)

(21) Appl. No.: 17/048,620

(22) PCT Filed: Apr. 23, 2019
(86) PCT No.: PCT/EP2019/060381

§ 371 Date: Oct. 19, 2020

(30) Foreign Application Priority Data
Apr. 19, 2018 (EP) 18168346.7
Sep. 10, 2018 (EP) 18193557.8

(51) Int. Cl. G02B 13/00; G02B 15/14; G02B 13/12; G02B 3/14

(52) U.S. Cl. CPC G02B 13/009; G02B 3/14; G02B 13/12; G02B 15/142

(57) ABSTRACT

The present invention relates to an optical zoom device (1), comprising: a first lens (31) having an adjustable focal length and comprising a container (41) filled with a transparent fluid (F), wherein the container (41) of the first lens (31) comprises an elastically deformable and transparent membrane (61) facing a transparent wall (21) of the container (41) of the first lens (31), a second lens (32) having an adjustable focal length, wherein the second lens (32) is arranged after the first lens (31) in an optical path (A) of the optical zoom device (1), wherein the second lens (32) comprises a container (42) filled with a transparent fluid (F), wherein the container (42) of the second lens (32) comprises an elastically deformable and transparent membrane (62) facing a transparent wall (22) of the container (42) of the second lens (32), and a light deflecting device (70) arranged in the optical path (A), wherein the second lens (32) is arranged after the light deflecting device (70) in the optical path (A).

The present invention relates to an optical zoom device.

Such optical zoom systems particularly comprise two basic characteristics, namely an adjustable focal length as well as a fixed image plane. Conventional optical zoom systems usually comprise several lens assemblies which can be displaced with respect to one another. Here, the focal length of the optical zoom system is continuously adjusted by said displacements of lens assemblies. Particularly, the individual lens assembly has to be displaced in a pre-defined manner so that complex mechanical/motorized systems are necessary for providing proper zooming.

Based on the above, the problem to be solved by the present invention is to provide an improved optical zoom device.

This problem is solved by an optical zoom device having the features of claim 1.

Preferred embodiments of the present invention are stated in the respective sub claims and are described below.

According to claim 1 the optical zoom device comprises:
a first lens having an adjustable focal length comprising a container filled with a transparent fluid (e.g. liquid), wherein the container comprises a transparent membrane facing a transparent wall of the container,
a second lens having an adjustable focal length arranged after the first lens in an optical path of the optical zoom device so that light entering the optical zoom device can pass through the first lens and thereafter through the second lens when travelling along the optical path, wherein the second lens comprises a container filled with a transparent fluid (e.g. liquid), wherein the container of the second lens comprises a transparent membrane facing a transparent wall of the container of the second lens, and
a light deflecting device arranged in the optical path, wherein the light deflecting device is particularly configured to deflect the optical path, and wherein the second lens is arranged after the light deflecting device in the optical path.

Particularly, preferred embodiments are stated in the sub claims and/or are described below in conjunction with the Figures. Each individual feature shown in the Figures and/or mentioned in the text relating to the Figures may be incorporated (also in an isolated fashion) into a claim relating to the device according to the present invention.

Particularly, the walls of the first and second lens comprise a fixed constant distance with respect to each other along the optical path.

Further, in case the optical zoom device also comprises a third lens having a container with a transparent wall facing a transparent membrane of the third lens (and a transparent fluid, e.g. liquid, between the membrane and the wall of the third lens), each two walls of the first, second and third lens comprise a fixed constant distance with respect to each other along the optical path of the device.

The respective wall can be flat or aspheric. Here, particularly, flat means that the respective wall comprises two parallel flat surfaces. Further, aspheric means that the respective wall comprises at least one curved surface that is aspheric.

Furthermore, particularly, the respective membrane of the first, second or third lens can be made of at least one of the following materials: a glass, a polymer, an elastomer, a plastic or any other transparent and stretchable or flexible material. For example, the respective membrane may be made out of a silicone-based polymer such as poly(dimethylsiloxane) also known as PDMS or a polyester material such as PET or a biaxially-oriented polyethylene terephtalate (e.g. “Mylar”). Further, said fluid preferably is or comprises a liquid metal, a gel, a liquid, a gas, or any transparent, absorbing or reflecting material which can be deformed. For example, the fluid may be a silicone oil. The first, second and/or third lens can have identical fluids (F, F′, F″). However the fluids of the lenses may also be different from one another.

Particularly, regarding the rigid lenses described herein, the notion rigid means that the respective element is formed out of a material or out of several materials that is/are in a solid state in contrast to the fluid of the lenses having an adjustable focal length. The respective rigid lens thus comprises a fixed focal length and may also be denoted as fixed lens.

Furthermore, particularly, the respective rigid lens can be formed out of a glass, a plastic, a polymer.

According to an embodiment, the optical zoom device comprises a rigid lens arranged in front of the light deflecting device (e.g. folding prism or mirror) in the optical path, particularly when the first lens is arranged after the light deflecting device in the optical path of the optical zoom device.

Further, in an embodiment, the optical zoom device comprises at least one rigid lens arranged after the light deflecting device and/or after the first lens in the optical path. The at least one rigid lens can be further arranged after the second lens or after the third lens in the optical path. Further, several rigid lenses can be arranged after the light deflecting device (e.g. folding prism or mirror) and/or after the first lens in the optical path. Further, the respective rigid lens can be arranged after the first lens or after the second or after the third lens in the optical path.

Furthermore, according to an embodiment of the optical zoom device, the optical zoom device comprises an image sensor arranged after the second lens or after the third lens in the optical path.

Furthermore, according to an embodiment, for adjusting the focal length of the first lens, the membrane of the first lens is connected to a circumferential lens shaping element of the first lens for defining an area of the membrane of the first lens having an adjustable curvature. Likewise, according to an embodiment, for adjusting the focal length of the second lens, the membrane of the second lens is connected to a circumferential lens shaping element of the second lens for defining an area of the membrane of the second lens having an adjustable curvature. Furthermore, in an embodiment, for adjusting the focal length of the third lens, the membrane of the third lens is connected to a circumferential lens shaping element of the third lens for defining an area of the membrane of the third lens having an adjustable curvature.

Further, according to an embodiment of the optical zoom device, the container of the first lens encloses a lens volume filled with the fluid and at least a first reservoir volume filled with the fluid and connected to the lens volume of the container of the first lens, wherein the container of the first lens comprises an elastically deformable first wall member adjacent the at least one first reservoir volume of the container of the first lens. Further, in an embodiment, the container of the second lens encloses a lens volume filled with the fluid and at least a first reservoir volume filled with the fluid and connected to the lens volume of the container of the second lens, wherein the container of the second lens comprises an elastically deformable first wall member adjacent the at least one first reservoir volume of the container of the second lens.

Furthermore, according to an embodiment, the container of the third lens encloses a lens volume filled with the fluid and at least a first reservoir volume filled with the fluid and connected to the lens volume of the container of the third lens, wherein the container of the third lens comprises an elastically deformable first wall member adjacent the at least one first reservoir volume of the container of the third lens.

Further, according to an embodiment of the optical zoom device, the elastically deformable first wall member of the container of the first lens is formed by the membrane of the first lens. Furthermore, in an embodiment, the elastically deformable first wall member of the container of the second lens is formed by the membrane of the second lens. Further, in an embodiment, the elastically deformable first wall member of the container of the third lens is formed by the membrane of the third lens.

According to a further embodiment of the optical zoom device, the at least one first reservoir volume of the container of the first lens is arranged laterally next to the lens volume of the container of the first lens in a direction perpendicular to the optical axis of the first lens. Further, according to an embodiment, the at least one first reservoir volume of the container of the second lens is arranged laterally next to the lens volume of the container of the second lens in a direction perpendicular to the optical axis of the second lens. Furthermore, in an embodiment, the at least one first reservoir volume of the container of the third lens is arranged laterally next to the lens volume of the container of the third lens in a direction perpendicular to the optical axis of the third lens.

Furthermore, according to an embodiment of the optical zoom device, the container of the first lens encloses a second reservoir volume connected to the lens volume of the container of the first lens, wherein the container of the first lens comprises an elastically deformable second wall member adjacent the second reservoir volume of the container of the first lens. Further, in an embodiment, the container of the second lens encloses a second reservoir volume connected to the lens volume of the container of the second lens, wherein the container of the second lens comprises an elastically deformable second wall member adjacent the second reservoir volume of the container of the second lens. Further, in an embodiment, the container of the third lens encloses a second reservoir volume connected to the lens volume of the container of the third lens, wherein the container of the third lens comprises an elastically deformable second wall member adjacent the second reservoir volume of the container of the third lens.

Further, according to an embodiment of the optical zoom device, the wall of the container of the first lens comprises a step, particularly for increasing the at least one first reservoir volume of the first lens. Further, according to an embodiment, the wall of the container of the second lens comprises a step, particularly for increasing the at least one first reservoir volume of the second lens. Further, according to an embodiment, the wall of the container of the third lens comprises a step, particularly for increasing the at least one first reservoir volume of the third lens.

Furthermore, according to an embodiment of the optical zoom device according to the present invention, the first and the second reservoir volume of the container of the first lens face each other in a direction perpendicular to the optical axis of the first lens, and are arranged on the same side of the lens volume of the container of the first lens or are arranged on opposite sides of the lens volume of the container of the first lens. Furthermore, in an embodiment, the first and the second reservoir volume of the container of the second lens face each other in a direction perpendicular to the optical axis of the second lens, and are arranged on the same side of the lens volume of the container of the second lens or are arranged on opposite sides of the lens volume of the container of the second lens. Further, according to an embodiment, the first and the second reservoir volume of the container of the third lens face each other in a direction perpendicular to the optical axis of the third lens, and are arranged on the same side of the lens volume of the container (of the third lens or are arranged on opposite sides of the lens volume of the container of the third lens.

Furthermore, according to an embodiment of the optical zoom device, the container of the first lens comprises a frame structure forming a lateral wall of the container of the first lens, wherein the frame structure of the container of the first lens comprises a first recess forming the lens volume of the container of the first lens that is covered by the membrane of the container of the first lens and particularly by the wall of the container of the first lens, and wherein the frame structure of the container of the first lens comprises a second recess forming the at least one first reservoir volume of the container of the first lens that is covered by the first wall member of the container of the first lens and particularly by the wall of the container of the first lens. Further, according to an embodiment, the container of the second lens comprises a frame structure forming a lateral wall of the container of the second lens, wherein the frame structure of the container of the second lens comprises a first recess forming the lens volume of the container of the second lens that is covered by the membrane of the container of the second lens and particularly by the wall of the container of the second lens, and wherein the frame structure of the container of the second lens comprises a second recess forming the at least one first reservoir volume of the container of the second lens that is covered by the first wall member of the container of the second lens and particularly by the wall of the container of the second lens. Further, according to an embodiment, the container of the third lens comprises a frame structure forming a lateral wall of the container of the third lens, wherein the frame structure of the container of the third lens comprises a first recess forming the lens volume of the container of the third lens that is covered by the membrane of the container of the third lens and particularly by the wall of the container of the third lens, and wherein the frame structure of the container of the third lens comprises a second recess forming the at least one first reservoir volume of the container of the third lens that is covered by the first wall member of the container of the third lens and particularly by the wall of the container of the third lens.

Furthermore, according to an embodiment of the optical zoom device, the frame structure of the container of the first lens comprises a third recess forming the second reservoir volume of the container of the first lens that is covered by the second wall member of the container of the first lens and particularly by the wall of the container of the first lens. Further, in an embodiment, the frame structure of the container of the second lens comprises a third recess forming the second reservoir volume of the container of the second lens that is covered by the second wall member of the container of the second lens and particularly by the wall of the container of the second lens. Further, according to an embodiment, the frame structure of the container of the third lens comprises a third recess forming the second reservoir volume of the container of the third lens that is covered by the second wall member of the container of the third lens and particularly by the wall of the container of the third lens.

Furthermore, according to an embodiment of the optical zoom device, the first recess of the frame structure of the first lens comprises a circumferential edge which forms the lens shaping element of the first lens. Further, according to an embodiment, the first recess of the frame structure of the second lens comprises a circumferential edge which forms the lens shaping element of the second lens. Further, according to an embodiment, the first recess of the frame structure of the third lens comprises a circumferential edge which forms the lens shaping element of the third lens.

Furthermore, according to an embodiment of the optical zoom device according to the present invention, the wall of the container of the first lens is an elastically deformable and transparent further membrane. Further, according to an embodiment, the wall of the container of the second lens is an elastically deformable and transparent further membrane. Further, according to an embodiment, the wall of the container of the third lens is an elastically deformable and transparent further membrane.

Furthermore, according to an embodiment of the optical zoom device, the further membrane of the first lens is connected to a circumferential further lens shaping element of the first lens for defining an area of the further membrane of the first lens having an adjustable curvature; and/or wherein the further membrane of the second lens is connected to a circumferential further lens shaping element of the second lens for defining an area of the further membrane of the second lens having an adjustable curvature. Further, according to an embodiment, the further membrane of the third lens is connected to a circumferential further lens shaping element of the third lens for defining an area of the further membrane of the third lens having an adjustable curvature.

Furthermore, according to an embodiment of the optical zoom device, the first recess of the frame structure of the first lens comprises a further circumferential edge which forms the further lens shaping element of the first lens. Further, according to an embodiment, the first recess of the frame structure of the second lens comprises a further circumferential edge which forms the further lens shaping element of the second lens; and/or wherein the first recess of the frame structure of the third lens comprises a further circumferential edge which forms the further lens shaping element of the third lens.

Furthermore, according to an embodiment of the optical zoom device, the lens volume of the first lens is separated by a transparent separation wall into a first lens volume part and a second lens volume part, wherein the first lens volume part of the first lens is connected to the first reservoir volume of the first lens and the second lens volume part of the first lens is connected to the second reservoir volume of the first lens. Further, in an embodiment, the lens volume of the second lens is separated by a transparent separation wall into a first lens volume part and second lens volume part, wherein the first lens volume part of the second lens is connected to the first reservoir volume of the second lens and the second lens volume part of the second lens is connected to the second reservoir volume of the second lens. Further, according to an embodiment, the lens volume of the third lens is separated by a transparent separation wall into a first lens volume part and second lens volume part, wherein the first lens volume part of the third lens is connected to the first reservoir volume of the third lens and the second lens volume part of the third lens is connected to the second reservoir volume of the third lens.

Furthermore, according to an embodiment of the optical zoom device, the first lens comprises an actuator that is configured to act on the elastically deformable first wall member of the container of the first lens to pump fluid from the at least one first reservoir volume of the first lens into the lens volume of the first lens or from the lens volume of the first lens into the at least one first reservoir volume of the first lens so as to change the curvature of said area of the membrane of the first lens and therewith the focal length of the first lens. Further, according to an embodiment, the second lens comprises an actuator that is configured to act on the elastically deformable first wall member of the container of the second lens to pump fluid from the at least one first reservoir volume of the second lens into the lens volume of the second lens or from the lens volume of the second lens into the at least one first reservoir volume of the second lens so as to change the curvature of said area of the membrane of the second lens and therewith the focal length of the second lens. Further, according to an embodiment, the third lens comprises an actuator that is configured to act on the elastically deformable first wall member of the container of the third lens to pump fluid from the at least one first reservoir volume of the third lens into the lens volume of the third lens or from the lens volume of the third lens into the at least one first reservoir volume of the third lens so as to change the curvature of said area of the membrane of the third lens and therewith the focal length of the third lens.

Furthermore, according to an embodiment, the actuator of the first lens is further configured to act on the elastically deformable second wall member of the container of the first lens to pump fluid from the second reservoir volume of the first lens into the lens volume of the first lens or from the lens volume of the first lens into the second reservoir volume of the first lens so as to change the curvature of said area of the membrane of the first lens and therewith the focal length of the first lens; and/or wherein the actuator of the second lens is further configured to act on the elastically deformable second wall member of the container of the second lens to pump fluid from the second reservoir volume of the second lens into the lens volume of the second lens or from the lens volume of the second lens into the second reservoir volume of the second lens so as to change the curvature of said area of the membrane of the second lens and therewith the focal length of the second lens. Further, according to an embodiment, the actuator of the third lens is further configured to act on the elastically deformable second wall member of the container of the third lens to pump fluid from the second reservoir volume of the third lens into the lens volume of the third lens or from the lens volume of the third lens into the second reservoir volume of the third lens so as to change the curvature of said area of the membrane of the third lens and therewith the focal length of the third lens.

Furthermore according to an embodiment of the optical zoom device, the first lens comprises an actuator that is configured to act on the elastically deformable first wall member of the container of the first lens to pump fluid from the first reservoir volume of the first lens into the first lens volume part of the first lens or from the first lens volume part of the first lens into the first reservoir volume of the first lens so as to change the curvature of said area of the membrane of the first lens and therewith the focal length of the first lens. Further, according to an embodiment, the second lens comprises an actuator that is configured to act on the elastically deformable first wall member of the container of the second lens to pump fluid from the first reservoir volume of the second lens into the first lens volume part of the second lens or from the first lens volume part of the second lens into the first reservoir volume of the second lens so as to change the curvature of said area of the membrane of the second lens and therewith the focal length of the second lens. Furthermore, according to an embodiment, the third lens comprises an actuator that is configured to act on the elastically deformable first wall member of the container of the third lens to pump fluid from the first reservoir volume of the third lens into the first lens volume part of the third lens or from the first lens volume part of the third lens into the first reservoir volume of the third lens so as to change the curvature of said area of the membrane of the third lens and therewith the focal length of the third lens.

Further, according to an embodiment of the optical zoom device according to the present invention, the actuator of the first lens is further configured to act on the elastically deformable second wall member of the container of the first lens to pump fluid from the second reservoir volume of the first lens into the second lens volume part of the first lens or from the second lens volume part of the first lens into the second reservoir volume of the first lens so as to change the curvature of said area of the further membrane of the first lens and therewith the focal length of the first lens. Furthermore, according to an embodiment, the actuator of the second lens is further configured to act on the elastically deformable second wall member of the container of the second lens to pump fluid from the second reservoir volume of the second lens into the second lens volume part of the second lens or from the second lens volume part of the second lens into the second reservoir volume of the second lens so as to change the curvature of said area of the further membrane of the second lens and therewith the focal length of the second lens. Further, according to an embodiment, the actuator of the third lens is further configured to act on the elastically deformable second wall member of the container of the third lens to pump fluid from the second reservoir volume of the third lens into the second lens volume part of the third lens or from the second lens volume part of the third lens into the second reservoir volume of the third lens so as to change the curvature of said area of the further membrane of the third lens and therewith the focal length of the third lens.

Furthermore, according to an embodiment of the optical zoom device, the actuator of the first lens comprises a piston structure configured to push against or to pull on the elastically deformable first wall member of the container of the first lens, and/or to push against or to pull on the elastically deformable second wall member of the container of the first lens. Further, in an embodiment, the actuator of the second lens comprises a piston structure configured to push against or to pull on the elastically deformable first wall member of the container of the second lens, and/or to push against or to pull on the elastically deformable second wall member of the container of the second lens. Further, according to an embodiment, the actuator of the third lens comprises a piston structure configured to push against or to pull on the elastically deformable first wall member of the container of the third lens, and/or to push against or to pull on the elastically deformable second wall member of the container of the third lens.

Furthermore, according to an embodiment of the optical zoom device, the actuator of the first lens comprises an electrically conducting coil that is connected to the piston structure of the actuator of the first lens and is configured to interact with a magnet of the actuator of the first lens so as to move the piston structure of the actuator of the first lens; and/or wherein the actuator of the second lens comprises an electrically conducting coil that is connected to the piston structure of the actuator of the second lens and is configured to interact with a magnet of the actuator of the second lens so as to move the piston structure of the actuator of the second lens. Further, according to an embodiment, the actuator of the third lens comprises an electrically conducting coil that is connected to the piston structure of the actuator of the third lens and is configured to interact with a magnet of the actuator of the third lens so as to move the piston structure of the actuator of the third lens.

Furthermore, according to an embodiment of the optical zoom device, the actuator of the first lens comprises a magnet that is connected to the piston structure of the actuator of the first lens and is configured to interact with an electrically conducting coil of the actuator of the first lens so as to move the piston structure of the actuator of the first lens. Furthermore, in an embodiment, the actuator of the second lens comprises a magnet that is connected to the piston structure of the actuator of the second lens and is configured to interact with an electrically conducting coil of the actuator of the second lens so as to move the piston structure of the actuator of the second lens. Further, in an embodiment, the actuator of the third lens comprises a magnet that is connected to the piston structure of the actuator of the third lens and is configured to interact with an electrically conducting coil of the actuator of the third lens so as to move the piston structure of the actuator of the third lens.

Furthermore according to an embodiment of the optical zoom device, the at least one first reservoir of the container of the first lens is filled such with said fluid that the elastically deformable first wall member of the container of the first lens comprises a convex bulge. Furthermore, according to an embodiment, the at least one first reservoir of the container of the second lens is filled such with said fluid that the elastically deformable first wall member of the container of the second lens comprises a convex bulge. Furthermore, in an embodiment, the at least one first reservoir of the container of the third lens is filled such with said fluid that the elastically deformable first wall member of the container of the third lens comprises a convex bulge.

Further, according to an embodiment of the optical zoom device, the second reservoir of the container of the first lens is filled such with said fluid that the elastically deformable second wall member of the container of the first lens comprises a convex bulge. Furthermore, in an embodiment, the second reservoir of the container of the second lens is filled such with said fluid that the elastically deformable second wall member of the container of the second lens comprises a convex bulge. Further, according to an embodiment, the second reservoir of the container of the third lens is filled such with said fluid that the elastically deformable second wall member of the container of the third lens comprises a convex bulge.

Furthermore, according to an embodiment of the optical zoom device, the container of the first lens encloses a lens volume filled with the fluid, wherein the container of the first lens further comprises a deformable lateral wall connected to the wall of the container of the first lens for adjusting the curvature of the area of the membrane of the first lens and therewith the focal length of the first lens. Further, in an embodiment, the container of the second lens encloses a lens volume filled with the fluid, wherein the container of the second lens further comprises a deformable lateral wall connected to the wall of the container of the second lens for adjusting the curvature of the area of the membrane of the second lens and therewith the focal length of the second lens. Furthermore, according to an embodiment, the container of the third lens encloses a lens volume filled with the fluid, wherein the container of the third lens further comprises a deformable lateral wall connected to the wall of the container of the third lens for adjusting the curvature of the area of the membrane of the third lens and therewith the focal length of the third lens.

Further, according to an embodiment of the optical zoom device, the first lens comprises an actuator that is configured to adjust the curvature of said area of the membrane of the first lens and therewith the focal length of the first lens, wherein the actuator of the first lens is configured to act on the lens shaping element of the first lens or on the wall of the container of the first lens to deform the lateral wall of the container of the first lens and adjust the curvature of the area of the membrane of the first lens. Furthermore, in an embodiment, the second lens comprises an actuator that is configured to adjust the curvature of said area of the membrane of the second lens and therewith the focal length of the second lens, wherein the actuator of the second lens is configured to act on the lens shaping element of the second lens or on the wall of the container of the second lens to deform the lateral wall of the container of the second lens and adjust the curvature of the area of the membrane of the second lens. Furthermore, according to an embodiment, the third lens comprises an actuator that is configured to adjust the curvature of said area of the membrane of the third lens and therewith the focal length of the second lens, wherein the actuator of the third lens is configured to act on the lens shaping element of the third lens or on the wall of the container of the third lens to deform the lateral wall of the container of the third lens and adjust the curvature of the area of the membrane of the third lens.

Furthermore, according to an embodiment of the optical zoom device, the light deflecting device is one of: a folding prism, a mirror, a tiltable mirror.

The present invention can be applied to a wide variety of different applications, particularly: Ophthalmology equipment such as phoropter, refractometer, pachymeter, ppt. biometrie, perimeter, refrakto-keratometer, refra. Lensanalyzer, tonometer, anomaloskop, kontrastometer, endothelmicroscope, anomaloscope, binoptometer, OCT, rodatest, ophthalmoscope, RTA, machine vision, cameras, mobile phone cameras, medical equipment, robot cams, virtual reality or augmented reality cameras, microscopes, telescopes, endoscopes, drone cameras, surveillance cameras, web cams, automotive cameras, motion tracking, binoculars, research, automotive, projectors, ophthalmic lenses, range finder, bar code readers etc.

In the following, further features as well as embodiments of the present invention are described with reference to the Figures that are appended to the claims, wherein:

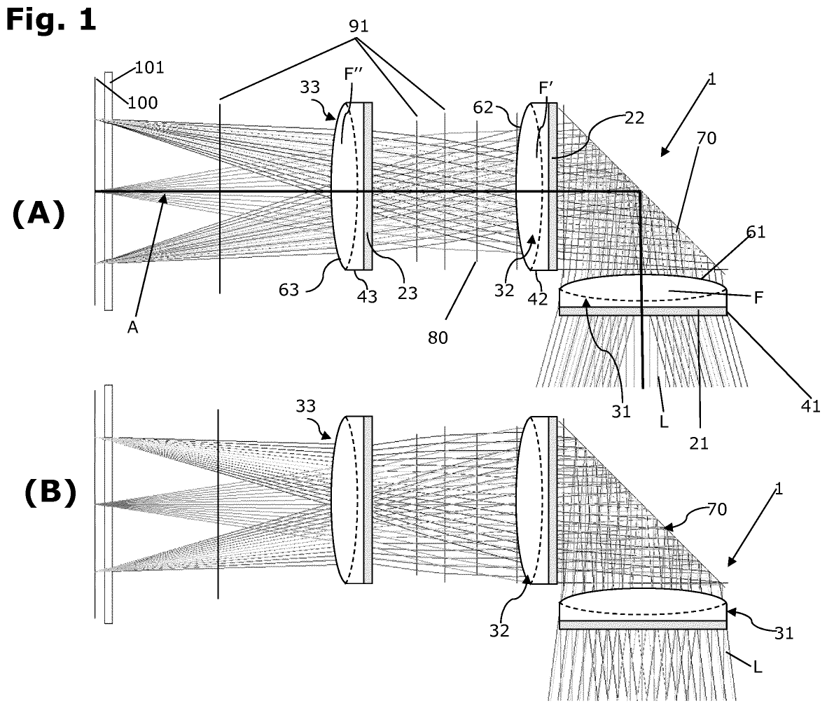

FIG. 1 shows a schematical cross-section of an embodiment of an optical zoom device according to the present invention;

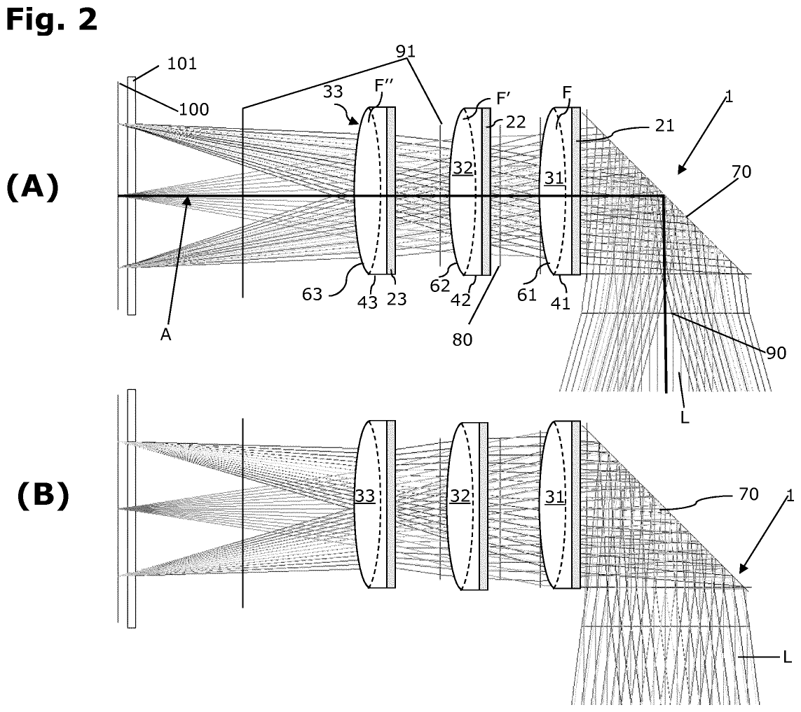

FIG. 2 shows a schematical cross-section of a further embodiment of an optical zoom device according to the present invention;

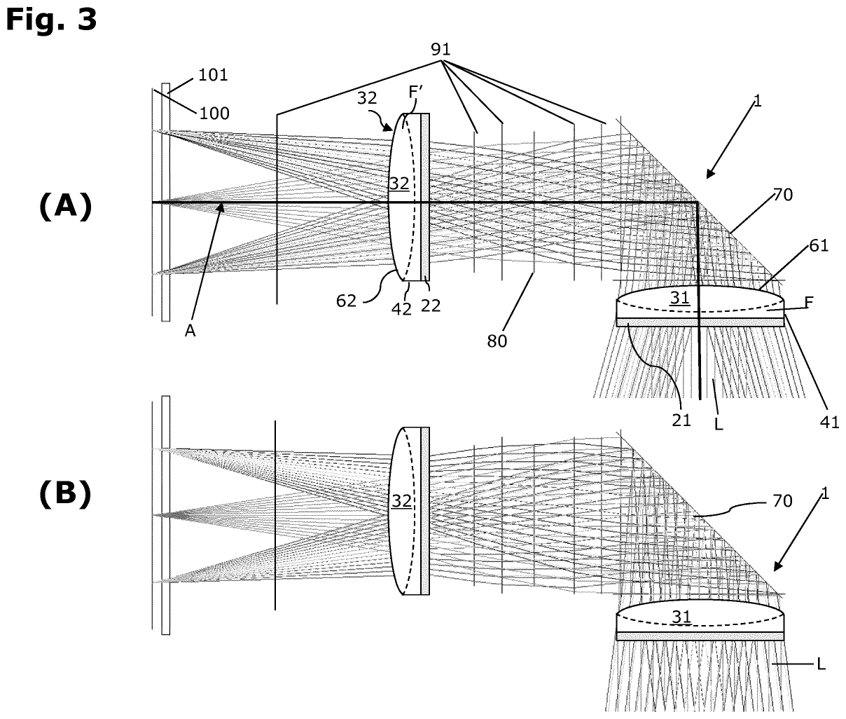

FIG. 3 shows a schematical cross-section of a further embodiment of an optical zoom device according to the present invention;

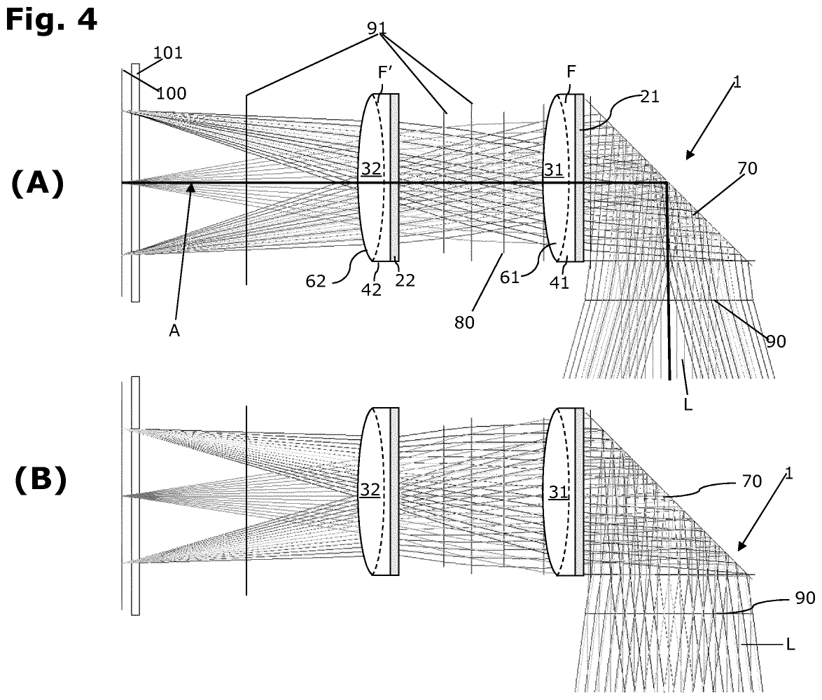

FIG. 4 shows a schematical cross-section of a further embodiment of an optical zoom device according to the present invention;

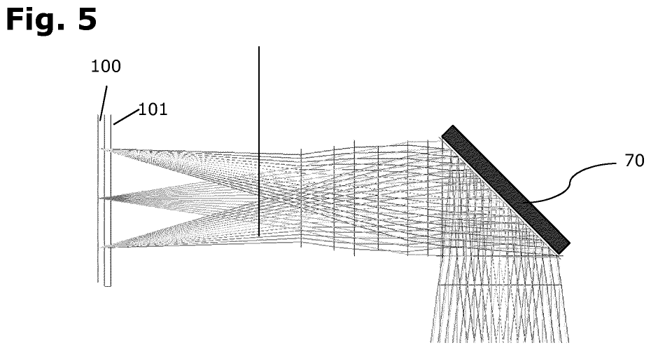

FIG. 5 shows an embodiment of the optical zoom device configured for performing optical image stabilization using the light deflecting device (particularly in the form of a tiltable mirror;

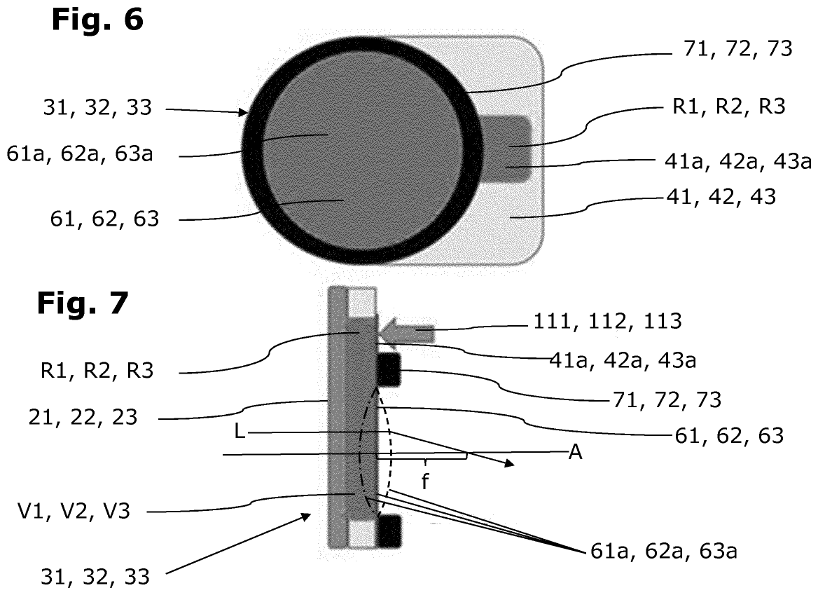

FIG. 6 shows a schematical plan view of a first, second or third lens of an optical zoom device according to the present invention having an adjustable focal length, respectively; the lens shaping element and container can be fixed to the system; particularly only a piston structure acting on the (first and/or second) reservoir leads to a convex (pushing into the reservoir(s)) or concave lens shape (pulling on the reservoir(s)); further, an overfilling of the respective lens volume/reservoir volume(s) helps to increase the possible stroke;

FIG. 7 shows a schematical cross section of the lens shown in FIG. 7.

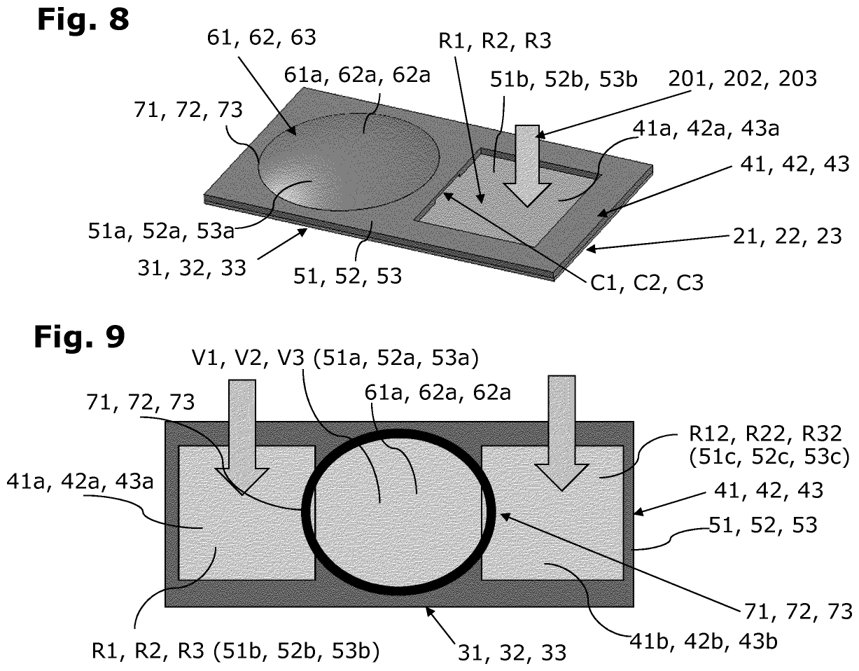

FIGS. 8 and 9 show an embodiment of a lens (first, second, and/or third lens) of the optical zoom device comprising a container having a flat frame structure comprising recesses for forming the lens volume/reservoir volume(s);

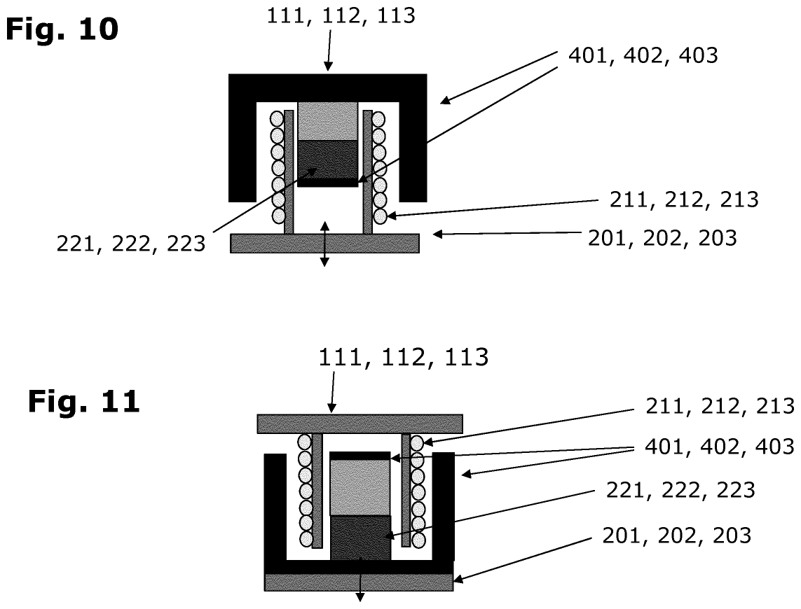

FIG. 10 shows an actuator of an optical zoom device according to the present invention comprising a moving coil;

FIG. 11 shows an actuator of an optical zoom device according to the present invention comprising a moving magnet;

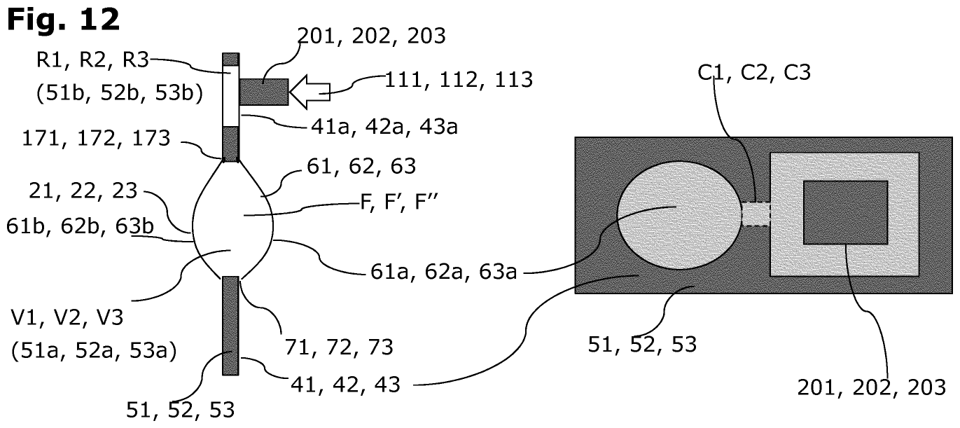

FIG. 12 shows cross-sectional view (left side) and a top view (right side) of an embodiment of a lens (first, second, and/or third lens) of the optical zoom device comprising a membrane instead of a hard wall for forming a e.g. biconvex or biconcave lens;

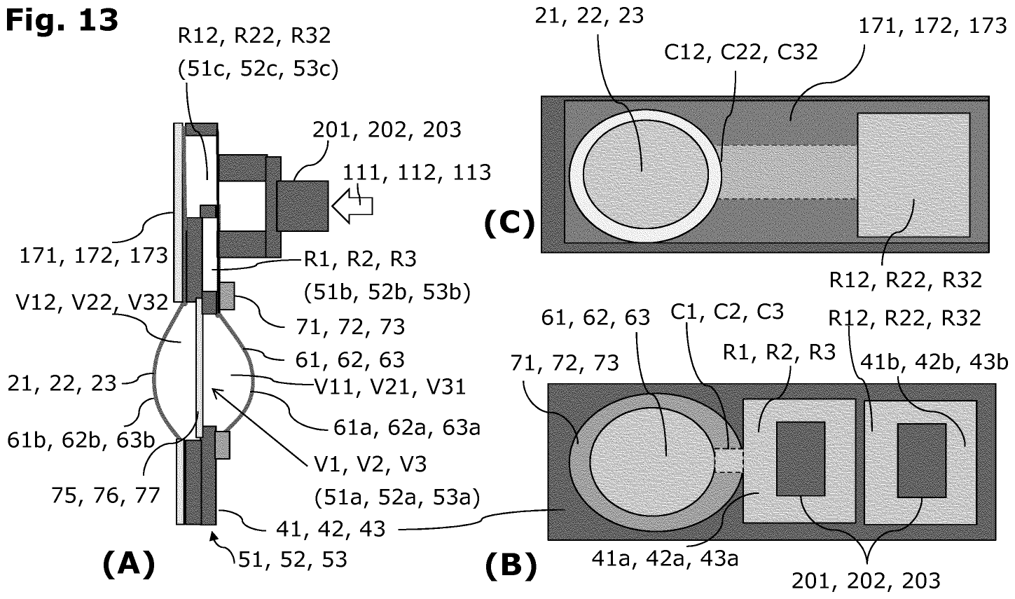

FIG. 13 shows cross-sectional view (left side), a top view (lower right side), and a bottom view (upper right side) of an embodiment of a lens (first, second, and/or third lens) of the optical zoom device comprising a lens volume separated into two separate volume parts;

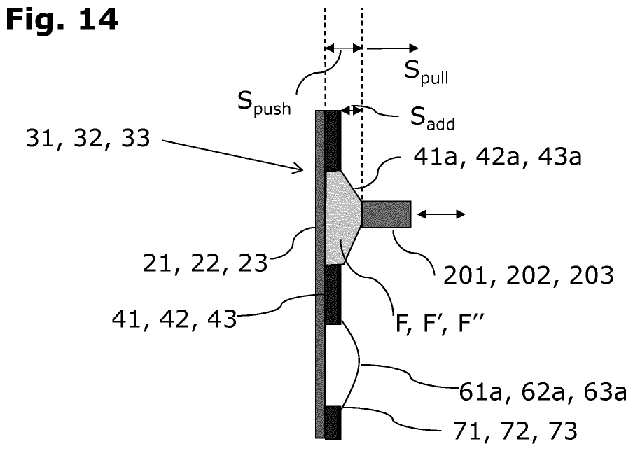

FIG. 14 shows overfilling of the reservoir volume to increase the stroke of the actuator;

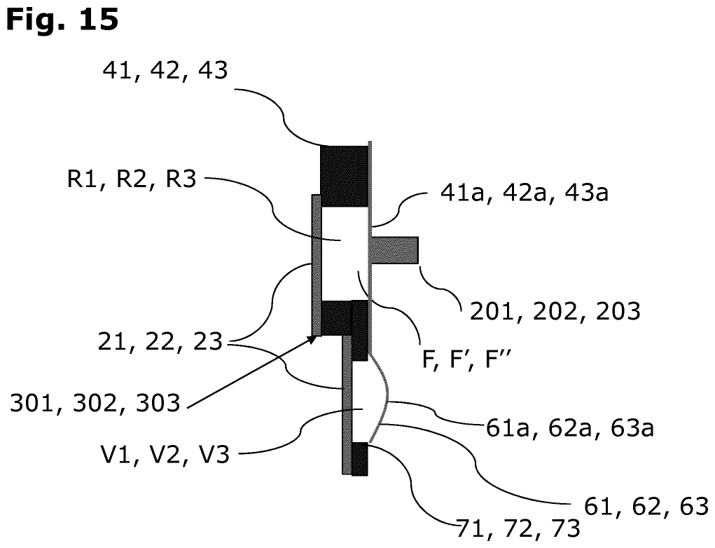

FIG. 15 shows increasing of the reservoir volume by providing a step on the container;

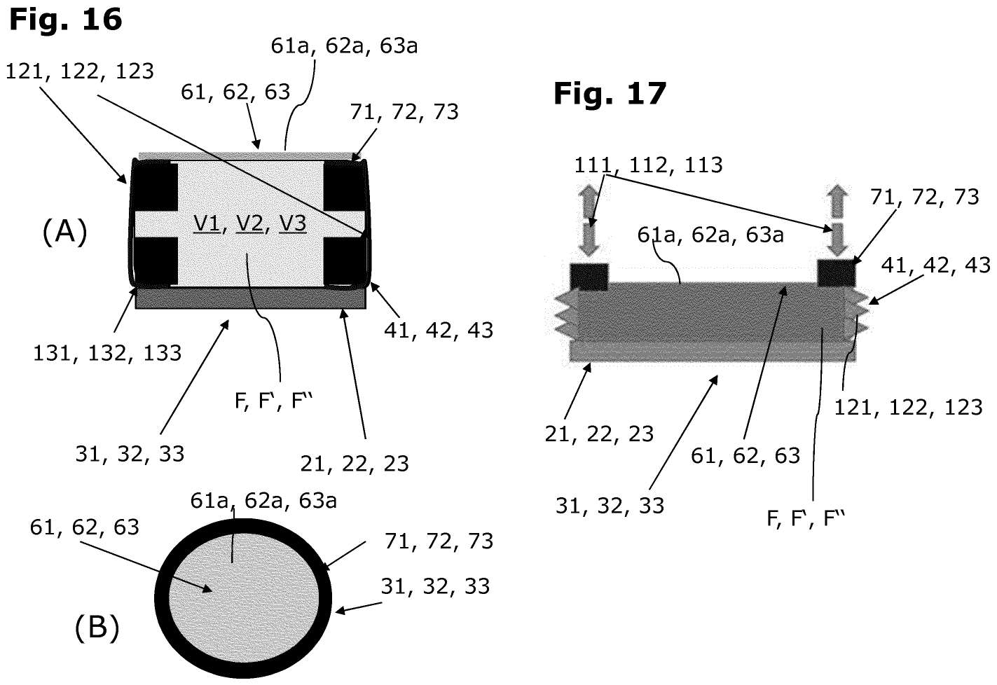

FIG. 16 shows an embodiment of a lens (first, second, and/or third lens) of an optical zoom device according to the present invention using a deformable lateral wall (e.g. a bellow), wherein particularly the lateral walls can be made out of a flexible material such as a thick membrane. By pushing on the lens shaping element, the deflection of the lateral wall leads to a convex lens form. By pulling on the lens shaping element, the membrane shape in the optical active area leads to a concave form. By using non-symmetric forces on the lens shaping element the (first, second, and/or third) lens is tilted leading to a tilted lens form which can be used for optical image stabilization; alternatively, the lens shaping element can be fixed to the optical system and the pusher (e.g. piston structure) can act on the cover glass/wall of the container (moving container).

FIG. 17 shows a bellow lens concept (deformable lateral wall of container) where the lateral wall(s) is/are made out of a flexible material (e.g. a foldable rubber material). By pushing on the lens shaping element, the deflection of the lateral wall(s) leads to a convex lens form. By pulling on the lens shaping element, the membrane shape in the optical active area leads to a concave form. By using non-symmetric forces on the lens shaping element, the lens is tilted leading to a tilted lens form which can be used for optical image stabilization; alternatively, the lens shaping element can be fixed to the optical system and the pusher (e.g. piston structure) can act on the cover glass (moving container).

The present invention relates to optical zoom devices 1. Particularly, the optical zoom device 1 is a mechanical assembly of lens elements for which the focal length (and thus angle of view) can be varied.

According to the present invention (cf. e.g. FIGS. 1 to 17) such an optical zoom device 1 particularly comprises at least an image sensor 100, fix focus corrective lenses 90, 91 (also denoted as rigid lenses herein) and at least a first and a second lens having an adjustable focal length 31, 32 (also denoted as tunable lenses). Particularly, theses lenses 31, 32 comprise a fixed distance to one another along an optical path A of the optical zoom device so that a complicated motorized displacement of rigid lenses with respect to one another can be omitted. Furthermore, an IR filter 101 can be arranged in front of the image sensor 100 in all embodiments.

According to a first embodiment shown in FIG. 1, light L can pass through the first lens 31 and thereafter through the light deflecting device 70 (e.g. folding prism or tiltable mirror, see below), the second lens 32 and the third lens 33 when travelling along the optical axis A and form an image on the image sensor 100 that can be zoomed by the device 1.

Thus, according to the embodiment shown in FIG. 1, the optical zoom device 1 comprises three tunable lenses 31, 32, 33 having an adjustable focal length, wherein one of the tunable lenses, e.g. the first lens 31, is arranged in front of the light deflecting device 70 and the other two tunable lenses, e.g. the second and the third lens 32, 32 are arranged behind the light deflecting device 70 (with respect to the optical path A/the direction of the light L incident on the first lens 31). According to an embodiment, the tuning range of the first, second, and/or third lens 31, 32, 33 lies within a range from −100 diopters to +100 diopters. Furthermore, the clear aperture range of the first, second and/or third lens 31, 32, 33 can lie in the range from 1.0 mm to 6.0 mm according to an embodiment (these diopter ranges and clear aperture ranges can also apply to the embodiments shown in FIGS. 2 to 4).

Furthermore, the optical zoom device 1 shown in FIG. 1 can comprise one or several rigid lenses 91 having a fixed focal length. The respective rigid lens 91 can e.g. be made from a plastic material or a glass. Further, the respective rigid lens 91 can have a spherical or an aspherical shape. For instance, in the example shown in FIG. 1, a rigid lens 91 can be arranged between the image sensor 100 and the third lens 33, and two further rigid lenses 91 can be arranged between the third lens 33 and the second lens with respect to the optical path A.

Furthermore, the optical zoom device 1 according to FIG. 1 can comprise an aperture stop 80. According to an embodiment, the aperture stop 80 can be arranged between the first lens 31 and the second lens 32, or between the second lens 32 and the third lens 33 (cf. FIG. 1), or between the third lens 33 and the image sensor 100. The respective tunable lens 31, 32, 33 can be designed according to the embodiments described herein (this also applies to FIGS. 2 to 4). Particularly, as indicated in FIG. 1 the respective tunable lens 31, 32, 33 comprises a container 41, 42, 43 filled with a transparent fluid F, F′, F″ (e.g. an optical liquid), wherein the respective container 41, 42, 43 comprises an elastically deformable and transparent membrane 61, 62, 63 (for adjusting the focal length of the respective lens) facing a transparent wall 21, 22, 23 of the respective container 41, 42, 43. The respective container 41, 42, 43 or wall 21, 22, 23 can have e.g. a flat or an aspheric shape.

Particularly, FIG. 1(A) shows the optical zoom device 1 in a wide angle configuration (larger field-of-view) while FIG. 1(B) shows the optical zoom device 1 in a tele angle configuration (smaller field-of-view)

FIG. 2 shows an embodiment of the optical zoom device 1, where the first lens 31 is arranged after the lens deflecting device (here e.g. folding prism) 70. Particularly, according to FIG. 2, all three tunable lenses 31, 32, 33 are arranged behind the light deflecting device 70 (e.g. prism) with respect to the optical path A/the direction of the light L incident on the first lens 31). According to FIG. 2, in contrast to FIG. 1, a rigid lens 90 having a fixed focal length is arranged in front of the light deflecting device 70. This rigid lens 90 can be made from a plastic material or a glass. It can have a spherical or an aspherical shape. Furthermore, further rigid lenses 91 having a fixed focus can be arranged between the image sensor 100 and the third lens 33 and between the third lens 33 and the second lens 32. Also these rigid lenses 91 can be made from a plastic material or a glass. Further, the rigid lenses 91 can each have a spherical shape or an aspherical shape.

As described in conjunction with FIG. 1 before, the optical zoom device 1 according to FIG. 2 can also comprise an aperture stop 80. According to an embodiment, this aperture stop 80 can be arranged in front of the first lens 31, or between the first lens 31 and the second lens 32 (cf. FIG. 2), or between the second lens 32 and the third lens 33, or between the third lens 33 and the image sensor 100.

Particularly, also here, FIG. 2(A) shows the optical zoom device 1 in a wide state (larger field-of-view) while FIG. 2(B) shows the optical zoom device 1 in a tele state (smaller field-of-view).

Furthermore, FIG. 3 shows an embodiment, wherein only a first lens 31 and a second lens 32 having adjustable focal lengths are used, wherein the first lens 31 is arranged in front of the light deflecting device 70 and the second lens 32 is arranged behind the light deflecting device 70.

Also here, the optical zoom device 1 can comprise one or several rigid lenses 91 having a fixed focal length. The respective rigid lens 91 can e.g. be made from a plastic material or a glass. Further, the respective rigid lens 91 can have a spherical or an aspherical shape. For instance, in the example shown in FIG. 3, a rigid lens 91 can be arranged between the image sensor 100 and the second lens 32, and a plurality of further rigid lenses 91 can be arranged between the second lens 32 and the light deflecting device 70 (e.g. folding prism) with respect to the optical path A/the direction of the light L incident on the first lens 31.

Furthermore, the optical zoom device 1 shown in FIG. 3 can also comprise an aperture stop 80. According to an embodiment, this aperture stop 80 can be arranged between the first lens 31 and the second lens 32 (cf. FIG. 3), or between the second lens 32 and the image sensor 100.

Particularly, the upper part (A) of FIG. 3 shows a wide angle configuration wherein the area 61a of the first lens 32 may comprise no curvature (i.e. is flat) while the area 62a of the second lens 32 is convex. Particularly, the lower part (B) of FIG. 3 shows a tele angle configuration, wherein the area 61a of the first lens 31 is convex and the area 62a of the second lens 32 is concave.

Further, FIG. 4 shows an embodiment, comprising two tunable lenses 31, 32, wherein here both the first lens 31 and the second lens 32 are arranged after the light deflecting device (e.g. folding prism) 70 with respect to the optical path A/the direction of the light L incident on the first lens 31.

As shown in FIG. 4, the optical zoom device 1 can comprise one or several rigid lenses 90, 91 having a fixed focal length. The respective rigid lens 90, 91 can e.g. be made from a plastic material or a glass. Further, the respective rigid lens 90, 91 can have a spherical or an aspherical shape. For instance, in the example shown in FIG. 4, a rigid lens 90 is arranged in front of the light deflecting device 70. Furthermore, a further rigid lens 91 can be arranged between the image sensor 100 and the second lens 32, and a plurality of further rigid lenses 91 can be arranged between the second lens 32 and the light deflecting device 70 (e.g. folding prism).

Furthermore, the optical zoom device 1 shown in FIG. 4 can also comprise an aperture stop 80. According to an embodiment, this aperture stop 80 can arranged in front of the first lens 31, or between the first lens 31 and the second lens 32 (cf. FIG. 4), or between the second lens 32 and the image sensor 100.

Particularly, the upper part (A) of FIG. 4 shows a wide angle configuration, wherein the area 61a of the first lens 31 is convex and the area 62a of the second lens 32 is convex, too. The lower part (B) of FIG. 4 shows a tele angle configuration, wherein the area 61a of the first lens 31 is concave, and the area 62a of the second lens 32 is concave, too.

Furthermore, particularly, the optical zoom device 1 according to the present invention forms a folded zoom module including liquid lenses. Particularly, the optical zoom device 1 according to the present invention can feature an optical image stabilization using (among others) e.g. one of:
a liquid prism, preferably at the entrance of the optical zoom device 1 because the same compensation of the image movement due to a movement of the device 1 can be achieved with a lower mechanical stroke at the entrance of the module (refer to earlier patent on prism),
tilting of the shaper (lens shaping element) of a liquid lens that imitates a liquid prism,
shifting one of the rigid spherical optical elements in two dimensions (x and y),
tilting the prism 70,
shifting the optical zoom device 1 in x,y,z.

Furthermore, in all embodiments described herein, the prism 70 can be replaced with a mirror as shown in FIG. 5. According to an embodiment, the mirror is tiltable in two dimensions (e.g. about two different axes)

In particular, in combination with liquid lenses when there is no optical element in front of the mirror 70 the field-of-view of the optical zoom device is narrow (e.g. smaller than 70°, preferably smaller than 30°.

Furthermore, the mirror size can be similar or smaller than the prism.

Furthermore, in contrast to the other optical image stabilization means listed above, tilting of the mirror 70 features a higher quality since no induction of errors in the image corners and no change of perspective occurs.

Particularly, the optical image stabilization is carried out in reflection which requires a much lower mechanical tilt to achieve the same optical tilt (the mechanical tilt corresponds to half the optical tilt while in transmission the mechanical tilt of a prism depends on the refractive index of the prism and is usually much larger (factor 2 to 10) than the optical tilt). As a consequence one can compensate much larger image errors for the same mechanical tilt

Particularly, the first, second and third lens 31, 32, 33 described above can e.g. each be designed as shown e.g. in FIGS. 6 and 7. According thereto, the respective lens 31, 32, 33 comprises a container 41, 42, 43 filled with a transparent fluid F, F′, F″, wherein the container 41, 42, 43 of the respective lens 31, 32, 33 comprises an elastically deformable and transparent membrane 61, 62, 63 facing a transparent wall 21, 22, 33 of the container 41, 42, 43 of the respective lens 31, 32, 33.

For adjusting the focal length of the respective lens 31, 32, 33, the membrane 61, 62, 63 of the respective lens 31, 32, 33 is connected to a circumferential lens shaping element 71, 72, 73 of the respective lens 31, 32, 33 for defining an area 61a, 62a, 63a of the membrane 61, 62, 63 that has an adjustable curvature. The curvature can be adjusted by pushing fluid F, F′, F″ against the membrane 61, 62, 63 or by reducing pressure of the fluid F, F′, F″ on the membrane 61, 62, 63.

To this end, the container 41, 42, 43 of the respective lens 31, 32, 33 encloses a lens volume V1 filled with the fluid F, F′, F″ and at least a first reservoir volume R1, R2, R3 filled with the fluid F, F′, F″ and connected to the lens volume V1, V2, V3 of the container 41, 42, 43 of the respective lens 31, 32, 33. Furthermore, the container 41, 42, 43 of the respective lens 31, 32, 33 comprises an elastically deformable first wall member 41a, 42a, 43a adjacent the at least one first reservoir volume R1, R2, R3 of the container 41, 42, 43 of the respective lens 31, 32, 33.

Furthermore, particularly, the elastically deformable first wall member 41a, 42a, 43a of the container 41, 42, 43 of the respective lens 31, 32, 33 can be formed by the membrane 61, 62, 63 of the respective lens 31, 32, 33.

Furthermore, as indicated in FIGS. 6 and 7, the at least one first reservoir volume R1, R2, R3 of the respective lens 31, 32, 33 is arranged laterally next to the lens volume V1, V2, V3 of the respective lens 31, 32, 33 in a direction perpendicular to the optical axis of the respective lens 31, 32, 33.

Now, for increasing or reducing pressure of the fluid F, F′, F″ on the membrane 61, 62, 63 of the respective lens 31, 32, 33, the latter comprises an actuator 111, 112, 113 that is configured to act on the elastically deformable first wall member 41a, 42a, 43a of the container 41, 42, 43 of the respective lens 31, 32, 33 to pump fluid F, F′, F″ from the at least one first reservoir volume R1, R2, R3 into the lens volume V1, V2, V3 of the respective lens 31, 32, 33 or from the lens volume V1, V2, V3 into the at least one first reservoir volume R1, R2, R3 of the respective lens 31, 32, 33 so as to change the curvature of said area 61a, 62a, 63a of the membrane 61, 62, 63 of the respective lens 31, 32, 33 and therewith the focal length of the respective lens 31, 32, 33. This is due to the fact that pumping more fluid F, F′, F″ into the respective lens volume V1, V2, V3 will bulge the area 61a, 62a, 63a further outwards (dashed line in FIG. 7), while pumping fluid F, F′, F″ out of the lens volume V1, V2, V3 will reduce this effect (e.g. so as to achieve a concave area 61a, 62a, 63a, see dash-dotted line in FIG. 7). This allows one to continuously change the curvature of the area 61a, 62a, 63a from e.g. convex to concave and to tune the focal length f of the lens 31, 32, 33 so that light L incident on the lens 31, 32, 33 will be deflected accordingly (shown in FIG. 7 for the convex area 61a, 62a, 63a).

Regarding the embodiment shown in FIGS. 6 and 7, several modifications are conceivable. For instance, instead of a rigid back cover glass/wall 21, 22, 23 one can add a further (second) membrane 21, 22, 23 (cf. e.g. FIG. 12). This doubles the possible optical power range in a single liquid lens which is important in an optical zoom device 1 to enhance the zoom factor. Furthermore, in general, the shape/outline of the container 41, 42, 43 can be adjusted such that it fits into the application. The container can be formed out of a metal, a plastic material or any other solid material. The respective material can be rigid or flexible, but is preferably always much stiffer than the membrane(s) 61, 62, 63, 21, 22, 23.

Furthermore, the lenses 31, 32, 33 described herein can feature at least one reservoir volume R1, R3, R3, but are not limited to one reservoir volume (see also below). Furthermore, the shape of the reservoir volume R1, R2, R3 and the shape of the fluid or liquid channel C1, C2, C3 can be adjusted such that they show the best performance.

Furthermore, according to the embodiment shown in FIG. 8, the first, second or third lens 31, 32, 33 can each comprise a container 41, 42, 43 that comprises a frame structure 51, 52, 53 forming a lateral wall of the container 41, 42, 43 of the respective lens 31, 32, 33, wherein the respective frame structure 51, 52, 53 comprises a first recess 51a, 52a, 53a forming the lens volume V1, V2, V3 that is covered by the membrane 61, 62, 63 and particularly by the wall 21, 22, 23 of the container 41, 42, 43 of the respective lens 31, 32, 33. Particularly the wall 21, 22, 23 of the respective lens 31, 32, 33 can be a cover glass that is particularly arranged on a backside of the frame structure 51, 52, 53. Furthermore, the first recess 51a, 52a, 53a of the frame structure 51, 52, 53 of the respective lens 31, 32, 33 comprises a circumferential edge 71, 72, 73 which forms the lens shaping element 71, 72, 73 of the respective lens 31, 32, 33.

Furthermore, the frame structure 51, 52, 53 of the container 41, 42, 43 of the respective lens 31, 32, 33 comprises a second recess 51b, 52b, 53b forming the at least one first reservoir volume R1, R2, R3 of the container 41, 42, 43 of the respective lens 31, 32, 33 that is covered by the first wall member 41a, 42a, 43a and particularly by the wall 21, 22, 23 of the container 41, 42, 43 of the respective lens 31, 32, 33. Particularly, the wall member 41a, 42a, 43a of the respective lens 31, 32, 33 can be formed by the membrane 61, 62, 63 of the respective lens and does not have to be provided as a separate member. Particularly, pumping liquid into optical active area V1, V2, V3 by pushing into the wall member/membrane 41a, 42a, 43a or pumping liquid F, F′, F″ out of the optical area V1, V2, V3 by pulling on the member 41a, 42a, 43a can be done using a piston 201, 202, 203 that is moved by an actuator 111, 112, 113.

Particularly, the lens volume V1, V2, V3 of the respective lens 31, 32, 33 can be connected to the reservoir volume R1, R2, R3 of the respective lens 31, 32, 33 via a fluidic channel C1, C2, C3. The fluidic channel C1, C2, C3 can be a recess formed into the frame structure 51, 52, 53 of the respective lens 31, 32, 33.

Furthermore, FIG. 9 shows a modification of the embodiment shown in FIG. 8, wherein here the container 41, 42, 43 of the respective lens 31, 32, 33 encloses a second reservoir volume R12, R22, R32 connected to the lens volume V1, V2, V3 of the respective lens 31, 32, 33. For pumping the second reservoir volume R12, R22, R32, the container 41, 42, 43 of the respective lens 31, 32, 33 comprises an elastically deformable second wall member 41b, 42b, 43b adjacent the second reservoir volume R12, R22, R32 of the respective lens 31, 32, 33.

The second reservoir volume R12, R22, R32 can be actuated by the same actuator as the first reservoir volume R1, R2, R3 or by a further actuator. Particularly, using two reservoir volumes allows push/pull stroke reduction of the actuator(s).

Further, as indicated in FIG. 9, the first and the second reservoir volume R1, R2, R3, R12, R22, R33 of the respective lens 31, 32, 33 can face each other in a direction perpendicular to the optical axis of the respective lens 31, 32, 33 and can be arranged on opposite sides of the central lens volume V1, V2, V3 of the respective lens 31, 32, 33.

Furthermore, the lens shaping element 71, 72, 73 for defining said area 61a, 62a, 63a of the membrane 61, 62, 63 of the respective lens 31, 32, 33 can be placed on top of container 41, 42, 43 in form of a separate lens shaping element 71, 72, 73.

Furthermore, the actuator 111, 112, 113 of the first, second or third lens 31, 32, 33 can e.g. be formed according to the embodiments shown in FIGS. 10 and 11.

FIG. 10 shows a moving coil actuator 111, 112, 113 of an optical zoom device 1 according to the present invention, i.e., the actuator 111, 112, 113 of the respective lens 31, 32, 33 comprises an electrically conducting coil 211, 212, 213 that is connected to the piston structure 201, 202, 203 of the actuator 111, 112, 113 of the respective lens 31, 32, 33 and is configured to interact with a fixed magnet 221, 222, 223 of the actuator 111, 112, 123 so as to move the piston structure 201, 202, 203 of the actuator 111, 112, 113 of the respective lens 31, 32, 33 when an electrical current is generated in the coil 211, 212, 213. The piston structure 201, 202, 203 is attached to the reservoir membrane/wall member 41a, 42a, 43a/41b, 42b, 43b to pump fluid F, F′, F″ residing in the respective reservoir volume.

The respective actuator 111, 112, 113 can comprise a return structure 401, 402, 403 connected to the fixed magnet 221, 222, 223 for guiding magnetic flux.

FIG. 11 shows an alternative design of an actuator of an optical zoom device 1 according to the present invention which is configured as a moving magnet actuator 111, 112, 113. Here, the actuator 111, 112, 113 of the respective lens 31, 32, 33 comprises a magnet 221, 222, 223 that is connected to the piston structure 201, 202, 203 of the actuator 111, 112, 113 of the respective lens 31, 32, 33 and is configured to interact with a fixed electrically conducting coil 211, 212, 213 of the actuator 111, 112, 113 of the respective lens 31 so as to move the piston structure 201, 202, 203 that is attached to the reservoir membrane/wall member 41a, 42a, 43a/41b, 42b, 43b to pump fluid F, F′, F″ residing in the respective reservoir volume when an electrical current is generated in the coil 211, 212, 213. In FIGS. 10 and 11 the movement direction of the piston structure 201, 202, 203 (e.g. push or pull) can e.g. be changed by changing the direction of the electrical current in the coil 211, 212, 213.

Also in case of a moving magnet actuator 111, 112, 113, the respective actuator 111, 112, 113 can comprise a return structure 401, 402, 403 connected to the moving magnet 221, 222, 223 for guiding magnetic flux.

FIG. 12 shows an embodiment of a lens (first, second, and/or third lens) of the optical zoom device 1 according to the present invention which comprises a transparent and elastically deformable membrane 21, 22, 23 instead of a hard wall 21, 22, 23 for forming a e.g. biconvex or biconcave lens.

Particularly, the further membrane 21, 22, 23 of the respective lens 31, 32, 33 is connected to a circumferential further lens shaping element 171, 172, 173 of the respective lens 31, 32, 33 for defining an area 61b, 62b, 63b of the further membrane 21, 22, 23 that comprises an adjustable curvature.

Particularly, in case the container 41, 42, 43 of the respective lens 31, 32, 33 comprises the frame structure 51, 52, 53 described above, the respective further lens shaping element 171, 172, 173 can be formed by a further circumferential edge 171, 172, 173 of the first recess 51a, 52a, 53a of the frame structure 51, 52, 53 of the respective lens 31, 32, 33. Also in this embodiment, the reservoir volume R1, R2, R3 can be actuated via a piston 201, 202, 203 that pushes against the elastically deformable wall member 41a, 42a, 43a or pulls on the latter to pump fluid F, F′, F″ back and forth between the reservoir volume R1, R2, R3 and the lens volume V1, V2, V3 to adjust the focal length of the respective lens 31, 32, 33 as described above.

Furthermore, FIG. 13 shows a modification of the embodiment shown in FIG. 12, wherein according to FIG. 13 the respective tunable lens (e.g. first, second or third) lens 31, 32, 33 can be formed as a biconvex/biconcave lens with a single actuator for actuating a piston structure 201, 202, 203 and two separate convex/concave lens volume parts V11, V21, V31, V12, V22, V32 that are each connected to an independent reservoir volume R1, R2, R3, R12, R22, R32. Preferably, a constant stroke on each reservoir R1, R2, R3, R12, R22, R32 of the system is used so that is becomes independent on the stiffness of the individual membranes 21, 22, 23, 61, 62, 63. Furthermore, the membranes 21, 22, 23, 61, 62, 63 on both sides can extend over the entire container 41, 42, 43 of the respective lens 31, 32, 33.

Particularly, FIG. 13 (A) shows a cross-sectional view of the respective lens 31, 32, 33, while FIG. 13 (B) shows a top view onto the membrane 61, 62, 63 and FIG. 13 (C) a bottom view onto the further membrane 21, 22, 23 of the respective lens 31, 32, 33.

As indicated in FIG. 13, separation of the lens volume parts V11, V21, V31, V12, V22, V32 of the respective lens 31, 32, 33 is achieved by a transparent separation wall (e.g. glass) 75, 76, 77, wherein the first lens volume part V11, V21, V31 of the respective lens 31, 32, 33 is connected to the first reservoir volume R1, R2, R3 of the respective lens 31, 32, 33, and the second lens volume part V12, V22, V32 of the respective lens 31, 32, 33 is connected to the second reservoir volume R12, R22, R32 of the respective lens 31, 32, 33.

Particularly, the actuator 111, 112, 113 of the respective lens 31, 32, 33 is configured to act at the same time through the piston structure 201, 202, 203 on the elastically deformable first wall member 41a, 42a, 43a adjacent the first reservoir volume R1, R2, R3 and on the elastically deformable second wall member 41b, 42b, 43b adjacent the second reservoir volume R12, R22, R32 of the container 41, 42, 43 of the respective lens 31, 32, 33 to pump fluid F, F′, F″ from the first reservoir volume R1, R2, R3 of the respective lens 31, 32, 33 into the first lens volume part V11, V21, V31 of the respective lens 31, 32, 33 (piston structure 201, 202, 203 pushes against first wall members 41a, 42a, 43a) or vice versa (piston structure 201, 202, 203 pulls on first wall members 41a, 42a, 43a) and to pump fluid F, F′, F″ from the second reservoir volume R12, R22, R32 into the second lens volume part V12, V22, V32 of the respective lens 31, 32, 33 (piston structure 201, 202, 203 pushes against second wall members 41b, 42b, 43b) or vice versa (piston structure 201, 202, 203 pulls on second wall members 41b, 42b, 43b) so as to change the curvatures of said areas 61a, 62a, 63a, 61b, 61b, 61b of the two membranes 61, 62, 63, 21, 22, 23 and therewith the focal length of the respective lens 31, 32, 33.

Furthermore, as shown in FIG. 13, the curvature-adjustable area 61a, 62a, 63a of the membrane 61, 62, 63 of the respective lens 31, 32, 33 can be defined/generated by means of a lens shaping element 71, 72, 73 (e.g. a shaper ring) arranged on the membrane 61, 62, 63. Likewise, the curvature-adjustable area 61b, 62b, 63b of the further membrane 21, 22, 23 of the respective lens 31, 32, 33 can be defined/generated by means of a further lens shaping element 71, 72, 73 arranged on the further membrane 21, 22, 23, wherein the further lens shaping element 171, 172, 173 can be formed as a plate member comprising an opening corresponding to the size of the area 61b, 62b, 63b.

Furthermore, the first reservoir volume R1, R2, R3 can be connected by a fluidic channel C1, C2, C3 to the first lens volume part V11, V12, V13 of the respective lens 31, 32, 33, wherein this fluidic channel C1, C2, C3 extends under the lens shaping element 71, 72, 73 of the respective lens 31, 32, 33. Similarly, the second reservoir volume R12, R22, R32 can be connected by a further fluidic channel C12, C22, C32 to the second lens volume part V12, V22, V32 of the respective lens 31, 32, 33, wherein the further fluidic channel C12, C22, C32 extends under the further lens shaping element 71, 72, 73 of the respective lens 31, 32, 33.

Furthermore, regarding FIG. 14, the respective reservoir volume R1, R2, R3 (or R12, R22, R32) can be overfilled to increase the stroke of the respective piston structure 201, 202, 203. Particularly, FIG. 14 shows the possible stroke Sₚᵤₛₕ for pushing against the wall member 41a, 42a, 43a, the stroke Sₚᵤₗₗ for pulling on the wall member 41a, 42a, 43a of the respective lens 31, 32, 33, and the additional stroke S_{add}.

Particularly, the respective first wall member 41a, 42a, 43a can comprise a bulge, particularly a convex bulge, particularly when the respective piston structure 201, 202, 203 is not pressing against the respective wall member 41a, 42a, 43a.

Particularly, with a slight liquid overfilling of the reservoir volumes R1, R2, R3 (and/or R12, R22, R32) one can increase the possible stroke for pushing into the respective reservoir volume (creation of a convex liquid lens).

Furthermore, by adjusting the free membrane (wall member 41a, 42, 43a) width and the width of the piston 201, 202, 203 the stroke and stroke force can be optimized.

By having different membrane stiffness of the reservoir membrane (wall member 41a, 42a, 43a), the force can be further optimized.

Furthermore, as demonstrated in FIG. 15, in case of limited space in x and y direction (i.e. parallel to the plane of the membrane 61, 62, 63), one can increase the first reservoir volume R1, R2, R3 by providing a step 301, 302, 303 in the container 41, 42, 43 of the respective lens 31, 32, 33. Particularly, the step can be formed in the wall 21, 22, 23 of the container 41, 42, 43 of the respective lens 31, 32, 33.

FIG. 16 shows an embodiment of a lens (first, second, and/or third lens) 31, 32, 33 of an optical zoom device 1 according to the present invention, wherein the container 41, 42, 43 of the respective lens 31, 32, 33 encloses a lens volume V1, V2, V3 filled with the fluid F, F′, F″, wherein the container 41, 42, 43 of the respective lens 31, 32, 33 further comprises a deformable lateral wall 121, 122, 123. Particularly, FIG. 16 (A) shows a cross-sectional view of the respective lens 31, 32, 33 whereas FIG. 16 (B) shows a top view onto the transparent and elastically deformable membrane 61, 62, 63 of the respective lens 31, 32, 33.

Particularly, the deformable lateral wall 121, 122, 123 can be connected via a ring structure 131, 132, 133 of the respective lens 31, 32, 33 to the wall 21, 22, 23 (e.g. cover glass) of the container 41, 42, 43 of the respective lens 31, 32, 33 and via the circumferential lens shaping element 71, 72, 73 to the membrane 61, 62, 63 of the respective lens 31, 32, 33. The deformable lateral wall 121, 122, 123 allows adjusting the curvature of the area 61a, 62a, 63a of the membrane 61, 62, 63 of the respective lens 31, 32, 33 and therewith the focal length of the respective lens 31, 32, 33. Particularly, the deformable lateral wall 121, 122, 123 can be a bellows or a flexible membrane (e.g. thicker than membrane 61, 62, 63).

In order to actually deform the lateral wall 121, 122, 123 so as to tune the focal length of the respective lens 31, 32, 33, the latter comprises according to FIG. 17 an actuator 111, 112, 113 that is configured to adjust the curvature of said area 61a, 62a, 63a of the membrane 61, 62, 63 of the first lens 31, 32, 33 and therewith the focal length of the first lens 31, 32, 33, by acting on the lens shaping element 71, 72, 73 of the respective lens 31, 32, 33 or on the wall 21, 22, 23 of the container 41, 42, 43 of the respective lens 31, 32, 33 to deform the lateral wall 121, 122, 123. Due to moving the lens shaping member 71, 72, 73 away or towards the wall 21, 22, 23 or due to moving the wall 21, 22, 23 towards or away from the lens shaping element 71, 72, 73, the pressure exerted on the membrane 61, 62, 63 changes accordingly which causes a corresponding change in the curvature of the optically active area 61a, 62a, 63a of the respective lens 31, 32, 33.

Particularly, by pushing on the lens shaping element 71, 72, 73 the deflection of the deformable lateral wall(s) 121, 122, 123 of the respective lens 31, 32, 33 leads to a convex lens form. By pulling on the lens shaping element 71, 72, 73, the membrane shape in the optical active area 61a, 62a, 63a, leads to a concave form. By using non-symmetric forces on the lens shaping element 71, 72, 73, the respective lens 31, 32, 33 is tilted leading to a tilted lens form which can be used for optical image stabilization; alternatively, the lens shaping element 71, 72, 73 can be fixed to the optical system and the pusher (e.g. piston structure) can act on the wall 21, 22, 23 of the respective lens 31, 32, 33.

1. Optical zoom device (1), comprising:
a first lens (31) having an adjustable focal length and comprising a container (41) filled with a transparent fluid (F), wherein the container (41) of the first lens (31) comprises an elastically deformable and transparent membrane (61) facing a transparent wall (21) of the container (41) of the first lens (31),
a second lens (32) having an adjustable focal length, wherein the second lens (32) is arranged after the first lens (31) in an optical path (A) of the optical zoom device (1), wherein the second lens (32) comprises a container (42) filled with a transparent fluid (F′), wherein the container (42) of the second lens (32) comprises an elastically deformable and transparent membrane (62) facing a transparent wall (22) of the container (42) of the second lens (32), and
a light deflecting device (70) arranged in the optical path (A), wherein the second lens (32) is arranged after the light deflecting device (70) in the optical path (A).

2. Optical zoom device according to claim 1, characterized in that the first lens (31) is arranged in front of the light deflecting device (70) or after the light deflecting device (70) in the optical path (A).

3. Optical zoom device according to claim 1, characterized in that the optical zoom device (1) comprises a third lens (33) having an adjustable focal length, the third lens (33) comprising a container (43) filled with a transparent fluid (F″), wherein the container (43) of the third lens (33) comprises an elastically deformable and transparent membrane (63) facing a transparent wall (23) of the container (43) of the third lens (33).

4. Optical zoom device according to claim 3, characterized in that the third lens (33) is arranged after the light deflecting device (70) in the optical path (A).

5. Optical zoom device according to claim 3, characterized in that the third lens (33) is arranged after the second lens (32) in the optical path (A).

6. Optical zoom device according to claim 1, characterized in that the optical zoom device (1) comprises an aperture stop (80) arranged in the optical path (A).

7. Optical zoom device according to claim 6, characterized in that the aperture stop (80) is arranged after the light deflecting device (70) in the optical path (A).

8. Optical zoom device according to claim 6, characterized in that the aperture stop (80) is arranged between the first lens (31) and the second lens (32) in the optical path (A).

9. Optical zoom device according to claim 3, characterized in that the aperture stop (80) is arranged between the second lens (32) and the third lens (33) in the optical path (A).

10. Optical zoom device according to claim 1, characterized in that the optical zoom device (1) comprises a rigid lens (90) arranged in front of the light deflecting device (70) in the optical path (A).

11. Optical zoom device according to claim 1, characterized in that the optical zoom device (1) comprises at least one rigid lens (91) arranged after the light deflecting device (70) and/or after first lens (31) in the optical path (A).

12. Optical zoom device according to claim 1, characterized in that the optical zoom device (1) comprises an image sensor (100) arranged after the second lens (32) or after the third lens (33) in the optical path (A).

13. Optical zoom device according to claim 1, characterized in that for adjusting the focal length of the first lens (31), the membrane (61) of the first lens (31) is connected to a circumferential lens shaping element (71) of the first lens (31) for defining an area (61a) of the membrane (61) of the first lens (31) having an adjustable curvature; and/or wherein for adjusting the focal length of the second lens (32), the membrane (62) of the second lens (32) is connected to a circumferential lens shaping element (72) of the second lens (32) for defining an area (62a) of the membrane (62) of the second lens (32) having an adjustable curvature; and/or wherein for adjusting the focal length of the third lens (33), the membrane (63) of the third lens (33) is connected to a circumferential lens shaping element (73) of the third lens (33) for defining an area (63a) of the membrane (63) of the third lens (33) having an adjustable curvature.

14. Optical zoom device according to claim 1, characterized in that the container (41) of the first lens (31) encloses a lens volume (V1) filled with the fluid (F) and at least a first reservoir volume (R1) filled with the fluid (F) and connected to the lens volume (V1) of the container (41) of the first lens (31), wherein the container (41) of the first lens (31) comprises an elastically deformable first wall member (41a) adjacent the at least one first reservoir volume (R1) of the container (41) of the first lens (31); and/or wherein the container (42) of the second lens (32) encloses a lens volume (V2) filled with the fluid (F′) and at least a first reservoir volume (R2) filled with the fluid (F′) and connected to the lens volume (V2) of the container (42) of the second lens (32), wherein the container (42) of the second lens (32) comprises an elastically deformable first wall member (42a) adjacent the at least one first reservoir volume (R2) of the container (42) of the second lens (32); and/or wherein the container (43) of the third lens (33) encloses a lens volume (V3) filled with the fluid (F″) and at least a first reservoir volume (R3) filled with the fluid (F″) and connected to the lens volume (V3) of the container (43) of the third lens (33), wherein the container (43) of the third lens (33) comprises an elastically deformable first wall member (43a) adjacent the at least one first reservoir volume (R3) of the container (43) of the third lens (33).

15. Optical zoom device according to claim 14, characterized in that the elastically deformable first wall member (41a) of the container (41) of the first lens (31) is formed by the membrane (61) of the first lens (31); and/or wherein the elastically deformable first wall member (42a) of the container (42) of the second lens (32) is formed by the membrane (62) of the second lens (32); and/or wherein the elastically deformable first wall member (43a) of the container (43) of the third lens (33) is formed by the membrane (63) of the third lens (33).

16. Optical zoom device according to claim 14, characterized in that the at least one first reservoir volume (R1) of the container (41) of the first lens (31) is arranged laterally next to the lens volume (V1) of the container (41) of the first lens (31) in a direction perpendicular to the optical axis of the first lens (31); and/or wherein the at least one first reservoir volume (R2) of the container (42) of the second lens (32) is arranged laterally next to the lens volume (V2) of the container (42) of the second lens (32) in a direction perpendicular to the optical axis of the second lens (32); and/or wherein the at least one first reservoir volume (R3) of the container (43) of the third lens (33) is arranged laterally next to the lens volume (V3) of the container (43) of the third lens (33) in a direction perpendicular to the optical axis of the third lens (33).

17. Optical zoom device according to claim 14, characterized in that that the container (41) of the first lens (31) encloses a second reservoir volume (R12) connected to the lens volume (V1) of the container (41) of the first lens (31), wherein the container (41) of the first lens (31) comprises an elastically deformable second wall member (41b) adjacent the second reservoir volume (R12) of the container (41) of the first lens (31); and/or wherein the container (42) of the second lens (32) encloses a second reservoir volume (R22) connected to the lens volume (V2) of the container (42) of the second lens (32), wherein the container (42) of the second lens (32) comprises an elastically deformable second wall member (42b) adjacent the second reservoir volume (R22) of the container (42) of the second lens (32); and/or wherein the container (43) of the third lens (33) encloses a second reservoir volume (R32) connected to the lens volume (V3) of the container (43) of the third lens (33), wherein the container (43) of the third lens (33) comprises an elastically deformable second wall member (43b) adjacent the second reservoir volume (R32) of the container (43) of the third lens (33).

18. Optical zoom device according to claim 1, characterized in that the wall (21) of the container (41) of the first lens (31) comprises a step (301), particularly for increasing the at least one first reservoir volume (R1) of the first lens (31); and/or wherein the wall (22) of the container (42) of the second lens (32) comprises a step (302), particularly for increasing the at least one first reservoir volume (R2) of the second lens (32); and/or wherein the wall (23) of the container (43) of the third lens (33) comprises a step (303), particularly for increasing the at least one first reservoir volume (R3) of the third lens (33).

19. Optical zoom device according to claim 17, characterized in that the first and the second reservoir volume (R1, R12) of the container (41) of the first lens (31) face each other in a direction perpendicular to the optical axis of the first lens (31), and are arranged on the same side of the lens volume (V1) of the container (41) of the first lens (31) or are arranged on opposite sides of the lens volume (V1) of the container (41) of the first lens (31); and/or wherein the first and the second reservoir volume (R2, R22) of the container (42) of the second lens (32) face each other in a direction perpendicular to the optical axis of the second lens (32), and are arranged on the same side of the lens volume (V2) of the container (42) of the second lens (32) or are arranged on opposite sides of the lens volume (V2) of the container (42) of the second lens (32); and/or wherein the first and the second reservoir volume (R3, R32) of the container (43) of the third lens (33) face each other in a direction perpendicular to the optical axis of the third lens (33), and are arranged on the same side of the lens volume (V3) of the container (43) of the third lens (33) or are arranged on opposite sides of the lens volume (V3) of the container (43) of the third lens (33).

20. Optical zoom device according to claim 14, characterized in that the container (41) of the first lens (31) comprises a frame structure (51) forming a lateral wall of the container (41) of the first lens (31), wherein the frame structure (51) of the container (41) of the first lens (31) comprises a first recess (51a) forming the lens volume (V1) of the container (41) of the first lens (31) that is covered by the membrane (61) of the container (41) of the first lens (31) and particularly by the wall (21) of the container (41) of the first lens (31), and wherein the frame structure (51) of the container (41) of the first lens (31) comprises a second recess (51b) forming the at least one first reservoir volume (R1) of the container (41) of the first lens (31) that is covered by the first wall member (41a) of the container (41) of the first lens (31) and particularly by the wall (21) of the container (41) of the first lens (31); and/or wherein the container (42) of the second lens (32) comprises a frame structure (52) forming a lateral wall of the container (42) of the second lens (32), wherein the frame structure (52) of the container (42) of the second lens (32) comprises a first recess (52a) forming the lens volume (V2) of the container (42) of the second lens (32) that is covered by the membrane (62) of the container (42) of the second lens (32) and particularly by the wall (22) of the container (42) of the second lens (32), and wherein the frame structure (52) of the container (42) of the second lens (32) comprises a second recess (52b) forming the at least one first reservoir volume (R2) of the container (42) of the second lens (32) that is covered by the first wall member (42a) of the container (42) of the second lens (32) and particularly by the wall (22) of the container (42) of the second lens (32); and/or wherein the container (43) of the third lens (33) comprises a frame structure (53) forming a lateral wall of the container (43) of the third lens (33), wherein the frame structure (53) of the container (43) of the third lens (33) comprises a first recess (53a) forming the lens volume (V3) of the container (43) of the third lens (33) that is covered by the membrane (63) of the container (43) of the third lens (33) and particularly by the wall (23) of the container (43) of the third lens (33), and wherein the frame structure (53) of the container (43) of the third lens (33) comprises a second recess (53b) forming the at least one first reservoir volume (R3) of the container (43) of the third lens (33) that is covered by the first wall member (43a) of the container (43) of the third lens (33) and particularly by the wall (23) of the container (43) of the third lens (33).

21. Optical zoom device according to claim 20, characterized in that the frame structure (51) of the container (41) of the first lens (31) comprises a third recess (51c) forming the second reservoir volume (R12) of the container (41) of the first lens (31) that is covered by the second wall member (41b) of the container (41) of the first lens (31) and particularly by the wall (21) of the container (41) of the first lens (31); and/or wherein the frame structure (52) of the container (42) of the second lens (32) comprises a third recess (51c) forming the second reservoir volume (R22) of the container (42) of the second lens (32) that is covered by the second wall member (42b) of the container (42) of the second lens (32) and particularly by the wall (22) of the container (42) of the second lens (32); and/or wherein the frame structure (53) of the container (43) of the third lens (33) comprises a third recess (51c) forming the second reservoir volume (R32) of the container (43) of the third lens (33) that is covered by the second wall member (43b) of the container (43) of the third lens (33) and particularly by the wall (23) of the container (43) of the third lens (33).

22. Optical zoom device according to claim 21, characterized in that the first recess (51a) of the frame structure (51) of the first lens (31) comprises a circumferential edge (71) which forms the lens shaping element (71) of the first lens (31); and/or wherein the first recess (52a) of the frame structure (52) of the second lens (32) comprises a circumferential edge (72) which forms the lens shaping element (72) of the second lens (32); and/or wherein the first recess (53a) of the frame structure (53) of the third lens (33) comprises a circumferential edge (73) which forms the lens shaping element (73) of the third lens (33).

23. Optical zoom device according to claim 1, characterized in that the wall (21) of the container (41) of the first lens (31) is an elastically deformable and transparent further membrane (21); and/or wherein the wall (22) of the container (42) of the second lens (32) is an elastically deformable and transparent further membrane (22); and/or wherein the wall (23) of the container (43) of the third lens (33) is an elastically deformable and transparent further membrane (23).

24. Optical zoom device according to claim 23, characterized in that the further membrane (21) of the first lens (31) is connected to a circumferential further lens shaping element (171) of the first lens (31) for defining an area (61b) of the further membrane (21) of the first lens (31) having an adjustable curvature; and/or wherein the further membrane (22) of the second lens (32) is connected to a circumferential further lens shaping element (172) of the second lens (32) for defining an area (62b) of the further membrane (22) of the second lens (32) having an adjustable curvature; and/or wherein the further membrane (23) of the third lens (33) is connected to a circumferential further lens shaping element (173) of the third lens (33) for defining an area (63b) of the further membrane (23) of the third lens (33) having an adjustable curvature.

25. Optical zoom device according to claim 24, characterized in that the first recess (51a) of the frame structure (51) of the first lens (31) comprises a further circumferential edge (171) which forms the further lens shaping element (171) of the first lens (31); and/or wherein the first recess (52a) of the frame structure (52) of the second lens (32) comprises a further circumferential edge (172) which forms the further lens shaping element (172) of the second lens (32); and/or wherein the first recess (53a) of the frame structure (53) of the third lens (33) comprises a further circumferential edge (173) which forms the further lens shaping element (173) of the third lens (33).

26. Optical zoom device according to claim 14, characterized in that, the lens volume (V1) of the first lens (31) is separated by a transparent separation wall (75) into a first lens volume part (V11) and a second lens volume part (V12), wherein the first lens volume part (V11) of the first lens (31) is connected to the first reservoir volume (R1) of the first lens (31) and the second lens volume part (V12) of the first lens (31) is connected to the second reservoir volume (R12) of the first lens (31); and/or wherein the lens volume (V2) of the second lens (32) is separated by a transparent separation wall (76) into a first lens volume part (V21) and second lens volume part (V22), wherein the first lens volume part (V21) of the second lens (32) is connected to the first reservoir volume (R2) of the second lens (32) and the second lens volume part (V22) of the second lens (31) is connected to the second reservoir volume (R22) of the second lens (32); and/or wherein the lens volume (V3) of the third lens (33) is separated by a transparent separation wall (77) into a first lens volume part (V31) and second lens volume part (V32), wherein the first lens volume part (V31) of the third lens (33) is connected to the first reservoir volume (R3) of the third lens (33) and the second lens volume part (V32) of the third lens (33) is connected to the second reservoir volume (R32) of the third lens (33).

27. Optical zoom device according to claim 14, characterized in that the first lens (31) comprises an actuator (111) that is configured to act on the elastically deformable first wall member (41a) of the container (41) of the first lens (31) to pump fluid (F) from the at least one first reservoir volume (R1) of the first lens (31) into the lens volume (V1) of the first lens (31) or from the lens volume (V1) of the first lens (31) into the at least one first reservoir volume (R1) of the first lens (31) so as to change the curvature of said area (61a) of the membrane (61) of the first lens (31) and therewith the focal length of the first lens (31); and/or wherein the second lens (32) comprises an actuator (112) that is configured to act on the elastically deformable first wall member (42a) of the container (42) of the second lens (32) to pump fluid (F′) from the at least one first reservoir volume (R2) of the second lens (32) into the lens volume (V2) of the second lens (32) or from the lens volume (V2) of the second lens (32) into the at least one first reservoir volume (R2) of the second lens (32) so as to change the curvature of said area (62a) of the membrane (62) of the second lens (32) and therewith the focal length of the second lens (32); and/or wherein the third lens (33) comprises an actuator (113) that is configured to act on the elastically deformable first wall member (43a) of the container (43) of the third lens (33) to pump fluid (F″) from the at least one first reservoir volume (R3) of the third lens (33) into the lens volume (V3) of the third lens (33) or from the lens volume (V3) of the third lens (33) into the at least one first reservoir volume (R3) of the third lens (33) so as to change the curvature of said area (63a) of the membrane (63) of the third lens (33) and therewith the focal length of the third lens (33).

28. Optical zoom device according to claim 14, characterized in that the actuator (111) of the first lens (31) is further configured to act on the elastically deformable second wall member (41b) of the container (41) of the first lens (31) to pump fluid (F) from the second reservoir volume (R12) of the first lens (31) into the lens volume (V1) of the first lens (31) or from the lens volume (V1) of the first lens (31) into the second reservoir volume (R12) of the first lens (31) so as to change the curvature of said area (61a) of the membrane (61) of the first lens (31) and therewith the focal length of the first lens (31); and/or wherein the actuator (112) of the second lens (32) is further configured to act on the elastically deformable second wall member (42b) of the container (42) of the second lens (32) to pump fluid (F′) from the second reservoir volume (R22) of the second lens (32) into the lens volume (V2) of the second lens (32) or from the lens volume (V2) of the second lens (32) into the second reservoir volume (R22) of the second lens (32) so as to change the curvature of said area (62a) of the membrane (62) of the second lens (32) and therewith the focal length of the second lens (32); and/or wherein the actuator (113) of the third lens (33) is further configured to act on the elastically deformable second wall member (43b) of the container (43) of the third lens (33) to pump fluid (F″) from the second reservoir volume (R32) of the third lens (33) into the lens volume (V3) of the third lens (33) or from the lens volume (V3) of the third lens (33) into the second reservoir volume (R32) of the third lens (33) so as to change the curvature of said area (63a) of the membrane (63) of the third lens (33) and therewith the focal length of the third lens (33).

29. Optical zoom device according to claim 14, characterized in that the first lens (31) comprises an actuator (111) that is configured to act on the elastically deformable first wall member (41a) of the container (41) of the first lens (31) to pump fluid (F) from the first reservoir volume (R1) of the first lens (31) into the first lens volume part (V11) of the first lens (31) or from the first lens volume part (V11) of the first lens (31) into the first reservoir volume (R1) of the first lens (31) so as to change the curvature of said area (61a) of the membrane (61) of the first lens (31) and therewith the focal length of the first lens (31); and/or wherein the second lens (32) comprises an actuator (112) that is configured to act on the elastically deformable first wall member (42a) of the container (42) of the second lens (32) to pump fluid (F′) from the first reservoir volume (R2) of the second lens (32) into the first lens volume part (V21) of the second lens (32) or from the first lens volume part (V21) of the second lens (32) into the first reservoir volume (R2) of the second lens (32) so as to change the curvature of said area (62a) of the membrane (62) of the second lens (32) and therewith the focal length of the second lens (32); and/or wherein the third lens (33) comprises an actuator (113) that is configured to act on the elastically deformable first wall member (43a) of the container (43) of the third lens (33) to pump fluid (F″) from the first reservoir volume (R3) of the third lens (33) into the first lens volume part (V31) of the third lens (33) or from the first lens volume part (V31) of the third lens (33) into the first reservoir volume (R3) of the third lens (33) so as to change the curvature of said area (63a) of the membrane (63) of the third lens (33) and therewith the focal length of the third lens (33).

30. Optical zoom device according to claim 14, characterized in that the actuator (111) of the first lens (31) is further configured to act on the elastically deformable second wall member (41b) of the container (41) of the first lens (31) to pump fluid (F) from the second reservoir volume (R12) of the first lens (31) into the second lens volume part (V12) of the first lens (31) or from the second lens volume part (V12) of the first lens (31) into the second reservoir volume (R12) of the first lens (31) so as to change the curvature of said area (61b) of the further membrane (21) of the first lens (31) and therewith the focal length of the first lens (31); and/or the actuator (112) of the second lens (32) is further configured to act on the elastically deformable second wall member (42b) of the container (42) of the second lens (32) to pump fluid (F′) from the second reservoir volume (R22) of the second lens (32) into the second lens volume part (V22) of the second lens (32) or from the second lens volume part (V22) of the second lens (32) into the second reservoir volume (R22) of the second lens (32) so as to change the curvature of said area (62b) of the further membrane (22) of the second lens (32) and therewith the focal length of the second lens (32); and/or the actuator (113) of the third lens (33) is further configured to act on the elastically deformable second wall member (43b) of the container (43) of the third lens (33) to pump fluid (F″) from the second reservoir volume (R32) of the third lens (33) into the second lens volume part (V32) of the third lens (33) or from the second lens volume part (V32) of the third lens (33) into the second reservoir volume (R32) of the third lens (33) so as to change the curvature of said area (63b) of the further membrane (23) of the third lens (33) and therewith the focal length of the third lens (33).

31. Optical zoom device according to claim 27, characterized in that the actuator (111) of the first lens (31) comprises a piston structure (201) configured to push against or to pull on the elastically deformable first wall member (41a) of the container (41) of the first lens (31), and/or to push against or to pull on the elastically deformable second wall member (41b) of the container (41) of the first lens (31); and/or wherein the actuator (112) of the second lens (32) comprises a piston structure (202) configured to push against or to pull on the elastically deformable first wall member (42a) of the container (42) of the second lens (32), and/or to push against or to pull on the elastically deformable second wall member (42b) of the container (42) of the second lens (32); and/or wherein the actuator (113) of the third lens (33) comprises a piston structure (203) configured to push against or to pull on the elastically deformable first wall member (43a) of the container (43) of the third lens (33), and/or to push against or to pull on the elastically deformable second wall member (43b) of the container (43) of the third lens (33).

32. Optical zoom device according to claim 31, characterized in that the actuator (111) of the first lens (31) comprises an electrically conducting coil (211) that is connected to the piston structure (201) of the actuator (111) of the first lens (31) and is configured to interact with a magnet (221) of the actuator (111) of the first lens (31) so as to move the piston structure (201) of the actuator (111) of the first lens (31); and/or wherein the actuator (112) of the second lens (32) comprises an electrically conducting coil (212) that is connected to the piston structure (202) of the actuator (112) of the second lens (32) and is configured to interact with a magnet (222) of the actuator (112) of the second lens (32) so as to move the piston structure (202) of the actuator (112) of the second lens (32); and/or wherein the actuator (113) of the third lens (33) comprises an electrically conducting coil (213) that is connected to the piston structure (203) of the actuator (113) of the third lens (33) and is configured to interact with a magnet (223) of the actuator (113) of the third lens (33) so as to move the piston structure (203) of the actuator (113) of the third lens (33).

33. Optical zoom device according to claim 31, characterized in that the actuator (111) of the first lens (31) comprises a magnet (221) that is connected to the piston structure (201) of the actuator (111) of the first lens (31) and is configured to interact with an electrically conducting coil (211) of the actuator (111) of the first lens (31) so as to move the piston structure (201) of the actuator (111) of the first lens (31); and/or wherein the actuator (112) of the second lens (32) comprises a magnet (222) that is connected to the piston structure (202) of the actuator (112) of the second lens (32) and is configured to interact with an electrically conducting coil (212) of the actuator (112) of the second lens (32) so as to move the piston structure (202) of the actuator (112) of the second lens (32); and/or wherein the actuator (113) of the third lens (33) comprises a magnet (223) that is connected to the piston structure (203) of the actuator (113) of the third lens (33) and is configured to interact with an electrically conducting coil (213) of the actuator (113) of the third lens (33) so as to move the piston structure (203) of the actuator (113) of the third lens (33).

34. Optical zoom device according to claim 14, characterized in that the at least one first reservoir (R1) of the container (41) of the first lens (31) is filled such with said fluid (F) that the elastically deformable first wall member (41a) of the container (41) of the first lens (31) comprises a convex bulge; and/or wherein the at least one first reservoir (R2) of the container (42) of the second lens (32) is filled such with said fluid (F′) that the elastically deformable first wall member (42a) of the container (42) of the second lens (32) comprises a convex bulge; and/or wherein the at least one first reservoir (R3) of the container (43) of the third lens (33) is filled such with said fluid (F″) that the elastically deformable first wall member (43a) of the container (43) of the third lens (33) comprises a convex bulge.

35. Optical zoom device according to claim 17, characterized in that the second reservoir (R12) of the container (41) of the first lens (31) is filled such with said fluid (F) that the elastically deformable second wall member (41b) of the container (41) of the first lens (31) comprises a convex bulge; and/or wherein the second reservoir (R22) of the container (42) of the second lens (32) is filled such with said fluid (F′) that the elastically deformable second wall member (42b) of the container (42) of the second lens (32) comprises a convex bulge; and/or wherein the second reservoir (R32) of the container (43) of the third lens (33) is filled such with said fluid (F″) that the elastically deformable second wall member (43b) of the container (43) of the third lens (33) comprises a convex bulge.

36. Optical zoom device according to claim 1, characterized in that, the container (41) of the first lens (31) encloses a lens volume (V1) filled with the fluid (F), wherein the container (41) of the first lens (31) further comprises a deformable lateral wall (121) connected to the wall (21) of the container (41) of the first lens (31) for adjusting the curvature of the area (61a) of the membrane (61) of the first lens (31) and therewith the focal length of the first lens (31); and/or wherein the container (42) of the second lens (32) encloses a lens volume (V2) filled with the fluid (F′), wherein the container (42) of the second lens (32) further comprises a deformable lateral wall (122) connected to the wall (22) of the container (42) of the second lens (32) for adjusting the curvature of the area (62a) of the membrane (62) of the second lens (32) and therewith the focal length of the second lens (32); and/or wherein the container (43) of the third lens (33) encloses a lens volume (V3) filled with the fluid (F″), wherein the container (43) of the third lens (33) further comprises a deformable lateral wall (123) connected to the wall (23) of the container (43) of the third lens (33) for adjusting the curvature of the area (63a) of the membrane (63) of the third lens (33) and therewith the focal length of the third lens (33).

37. Optical zoom device according to claim 13, characterized in that the first lens (31) comprises an actuator (111) that is configured to adjust the curvature of said area (61a) of the membrane (61) of the first lens (31) and therewith the focal length of the first lens (31), wherein the actuator (111) of the first lens (31) is configured to act on the lens shaping element (71) of the first lens (31) or on the wall (21) of the container (41) of the first lens (31) to deform the lateral wall (121) of the container (41) of the first lens (31) and adjust the curvature of the area (61a) of the membrane (61) of the first lens (31); and/or wherein the second lens (32) comprises an actuator (112) that is configured to adjust the curvature of said area (62a) of the membrane (62) of the second lens (32) and therewith the focal length of the second lens (32), wherein the actuator (112) of the second lens (32) is configured to act on the lens shaping element (72) of the second lens (32) or on the wall (22) of the container (42) of the second lens (32) to deform the lateral wall (122) of the container (42) of the second lens (32) and adjust the curvature of the area (62a) of the membrane (62) of the second lens (32); and/or wherein the third lens (33) comprises an actuator (113) that is configured to adjust the curvature of said area (63a) of the membrane (63) of the third lens (33) and therewith the focal length of the second lens (33), wherein the actuator (113) of the third lens (33) is configured to act on the lens shaping element (73) of the third lens (33) or on the wall (23) of the container (43) of the third lens (33) to deform the lateral wall (123) of the container (43) of the third lens (33) and adjust the curvature of the area (63a) of the membrane (63) of the third lens (33).

38. Optical zoom device according to claim 1, characterized in that the light deflecting device (70) is one of: a folding prism (70), a mirror (70), a tiltable mirror (70).

39. Optical zoom device according to claim 1, characterized in that both the first lens (31) and the second lens (32) are arranged after the light deflecting device (70) with respect to the optical path (A).
